(19) United States
(12) Patent Application Publication
(10) Pub. No.: US 2016/0275123 A1
(43) Pub. Date: Sep. 22, 2016

(54) PIPELINE EXECUTION OF MULTIPLE MAP-REDUCE JOBS

(71) Applicant: HITACHI, LTD., Tokyo (JP)

(72) Inventors: WUJUAN LIN, SINGAPORE (SG); WEI XIANG GOH, SINGAPORE (SG); HIROKAZU IKEDA, SINGAPORE (SG); NAOTO MATSUNAMI, SINGAPORE (SG)

(21) Appl. No.: 14/661,189

(22) Filed: Mar. 18, 2015

(51) Int. Cl. G06F 17/30; G06F 9/48

(52) U.S. Cl. CPC G06F 17/30345; G06F 9/4881

(57) ABSTRACT

Some examples include a pipeline manager that creates pipeline queues across data nodes in a cluster. The pipeline manager may assign a pipeline queue connection to contiguous map-reduce jobs so that a reduce task of a first map-reduce job sends data to the pipeline queue, and a map task of a second map-reduce job receives the data from the pipeline queue. Thus, the map task of the second job may begin using the data from the reduce task of the first job prior to completion of the first job. Furthermore, in some examples, the data nodes in the cluster may monitor access success to individual pipeline queues. If the access attempts to access successes exceeds a threshold, a data node may request an additional pipeline queue connection for a task. Additionally, if a failure occurs, information maintained at a data node may be used by the pipeline manager for recovery.

### BACKGROUND

A map-reduce framework and similar parallel processing paradigms may be used for batch analysis of large amounts of data. For example, some map-reduce frameworks, may employ a plurality of data node computing devices arranged in a cluster. The cluster of data nodes may receive data for a map-reduce job, and a workflow configuration may be used to drive the data through the data nodes. Conventionally, multiple map-reduce jobs may be executed in sequence so that a first map-reduce job is executed within the map-and-reduce framework, and the output from the first map-reduce job may be used as input for the second map-reduce job. However, execution of multiple map-reduce jobs in sequence may not enable data analysis and decision making in a short time window.

Furthermore, in a large map-reduce cluster, the amount of computation capacity and other resources available from each data node may change dynamically, such as when new map-reduce jobs are submitted or existing map-reduce jobs are completed. This can create difficulties in maximizing and/or optimizing utilization of system resources when processing multiple map-reduce jobs, such as when performing analysis on a large amount of data over a short period of time.

### SUMMARY

In some implementations, a pipeline execution technique may include creation of in-memory pipeline queues between a first map-reduce job and a second map-reduce job that may use at least some output of the first map-reduce job. For instance, a mapping task of the second map-reduce job can directly obtain results from a reducing task of the first map-reduce job, without waiting for the first map-reduce job to complete. In addition, to maximize utilization of system resources, connections to the pipeline queues may be dynamically assigned based on the available resources of the data nodes where the map tasks and reduce tasks are executed. Furthermore, in some examples, a pipeline manager and data nodes may maintain pipeline access information, and may cooperatively recover pipeline execution from a map task failure, a reduce task failure and/or a pipeline queue failure.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example multiple map-reduce job pipeline framework according to some implementations.

FIG. 2 illustrates an example system architecture for pipeline execution of multiple map-reduce jobs according to some implementations.

FIG. 3 illustrates an example pipeline manager computing device according to some implementations.

FIG. 4 illustrates an example data node computing device according to some implementations.

FIG. 5 is a flow diagram illustrating an example process for processing multiple contiguous jobs in map-reduce pipelines according to some implementations.

FIG. 6 is a flow diagram illustrating an example process for creating a map-reduce pipeline according to some implementations.

FIG. 7 is a flow diagram illustrating an example process for creating a map-reduce pipeline queue according to some implementations.

FIG. 8 illustrates an example structure of a pipeline queue management table for maintaining information about pipeline queues corresponding to particular jobs according to some implementations.

FIG. 9 illustrates an example structure of a pipeline assignment table according to some implementations.

FIG. 10 is a flow diagram illustrating an example process for a pipeline queue write according to some implementations

FIG. 11 illustrates an example structure of a data dispatching information table according to some implementations.

FIG. 12 is a flow diagram illustrating an example process for pipeline assignment according to some implementations.

FIG. 13 is a flow diagram illustrating an example process for pipeline queue connection according to some implementations.

FIG. 14 illustrates an example structure of a data produced information table according to some implementations.

FIG. 15 illustrates an example structure of a data consumed information table according to some implementations.

FIG. 16 illustrates an example structure of a pipeline queue access information table according to some implementations.

FIG. 17 illustrates an example structure of a data format table according to some implementations.

FIG. 18 is a flow diagram illustrating an example process for a pipeline queue read according to some implementations.

FIG. 19 illustrates an example structure of a data receiving information table according to some implementations.

FIG. 20 is a flow diagram illustrating an example process for pipeline queue access monitoring according to some implementations.

FIG. 21 is a flow diagram illustrating an example process for destroying a pipeline according to some implementations.

FIG. 22 is a flow diagram illustrating an example process for deleting a pipeline queue according to some implementations.

FIG. 23 is a flow diagram illustrating an example process for pipeline queue failure recovery according to some implementations.

### DETAILED DESCRIPTION

Some examples herein are directed to techniques and arrangements for enabling analysis of large data sets using a map-reduce paradigm. For instance, multiple analysis jobs may be processed in parallel to analyze a large amount of data within a short window of time, such as for enabling timely decision making for business intelligence and/or other purposes.

In some implementations, a pipeline manager creates in-memory pipeline queues across data nodes in a map-reduce cluster. The pipeline manager may assign a pipeline queue connection to contiguous map-reduce jobs. Thus, a reduce task of a first map-reduce job may be connected to a particular pipeline queue to send data to the particular pipeline queue. Further, a map task of a second map-reduce job may also be connected to the particular pipeline queue to receive the data from the particular pipeline queue. Accordingly, the map task of the second map-reduce job may begin receiving and using the data from the reduce task of the first map-reduce job prior to completion of the processing of the first map-reduce job.

Furthermore, the resource utilization in the cluster may be imbalanced due to some map tasks or reduce tasks using more computation capacity than other map tasks or reduce tasks. Thus, the resource utilization of data nodes where the map and/or reduce tasks are executed may change dynamically, e.g., due to a new job being submitted or an existing job being completed. Accordingly, to maximize utilization of system resources under such dynamic conditions, during the pipeline execution, each data node may execute periodically a pipeline queue access monitoring module. Based at least in part on the output(s) of the pipeline queue access monitoring module(s) at each data node, additional pipeline queue connections may be assigned to reduce tasks or map tasks that produce or consume data faster than other reduce tasks or map tasks, respectively.

In some implementations, the data nodes in the cluster may monitor access success to individual pipeline queues. For instance, if a ratio of the number of access attempts to the number of successful accesses exceeds a threshold, a data node may request an additional pipeline queue connection. The ratio may be indicative of a disparity between the relative speed at which two tasks connected to a particular pipeline queue are producing or consuming data. As one example, if a reduce task of a first map-reduce job produces results slowly, such as due to a heavy workload, the corresponding map task of the second map-reduce job may have to wait. As a result, resources of the respective data nodes may not be fully utilized and overall system performance is not maximized. Thus, some examples herein enable the pipeline manager to add dynamically additional queue connections to help maximize utilization of system resources. Accordingly, in some instances, there is not a one-to-one pipeline queue connection between map tasks and reduce tasks or vice versa.

In addition, in some cases, if a failure occurs, information maintained at one or more of the data nodes may be used by the pipeline manager for recovery of a failed task or for recovery of a failed pipeline queue. As one example, in response to failure of a reduce task or a map task, the failed task may be rescheduled by a job tracker. For instance, the rescheduled task may continue to use one or more existing pipeline queues to which the failed task was previously connected. Thus, when a rescheduled reduce task is ready to write data into a pipeline queue, the rescheduled reduce task data node may send a pipeline assignment request to the pipeline manager, and may indicate the request type as “recovery”. Similarly, when a rescheduled map task is ready to read data from a pipeline queue, the rescheduled map task data node may send a pipeline assignment request to the pipeline manager, and may indicate the request type as “recovery”.

In response to receiving a recovery type pipeline assignment request, the pipeline manager may determine, from one or more of the data nodes, byte ranges previously written (in the case of a rescheduled reduce task) or byte ranges previously consumed (in the case of a rescheduled map task). For a rescheduled reduce task, the pipeline manager may instruct the rescheduled reduce task to write data that does not include the byte ranges already written to the pipeline queues. For a rescheduled map task, the pipeline manger may instruct the corresponding reduce task node(s) to rewrite to the pipeline queues byte ranges of data already consumed by the failed map task. Thus, the pipeline manager and the data nodes may cooperatively recover from the failure of a reduce task or a map task.

As another example, in response to receiving an indication of failure of a pipeline queue, the pipeline manager may send a request to a first data node to create a new pipeline queue, and may receive a pipeline queue identifier for the new pipeline queue. The pipeline manager may further send the pipeline queue identifier to additional data nodes corresponding to reduce tasks and map tasks to enable the reduce tasks and the map tasks to be connected via the new pipeline queue. In addition, the pipeline manager may determine the byte ranges dispatched or otherwise written by the reduce tasks based on information maintained by the data nodes that were executing the reduce tasks prior to the failure of the pipeline queue. Additionally, or alternatively, the pipeline manager may determine the byte ranges received by the map tasks based on information maintained by data nodes that were executing the map tasks prior to the failure. From this information, the pipeline manager may determine the byte ranges of data lost due to the pipeline queue failure. The pipeline manager may instruct the reduce task node(s) and the map task node(s) to connect to the new pipeline queue, and may send an instruction to the reduce task node(s) to resend the lost byte ranges of data to the new pipeline queue. Thus, the pipeline manager and the data nodes may cooperatively recover pipeline execution from the failure of the pipeline queue.

For ease of understanding, some example implementations are described in the environment of a map-reduce cluster. However, implementations herein are not limited to the particular examples provided, and may be extended to other types of devices, other execution environments, other system architectures, and so forth, as will be apparent to those of skill in the art in light of the disclosure herein.

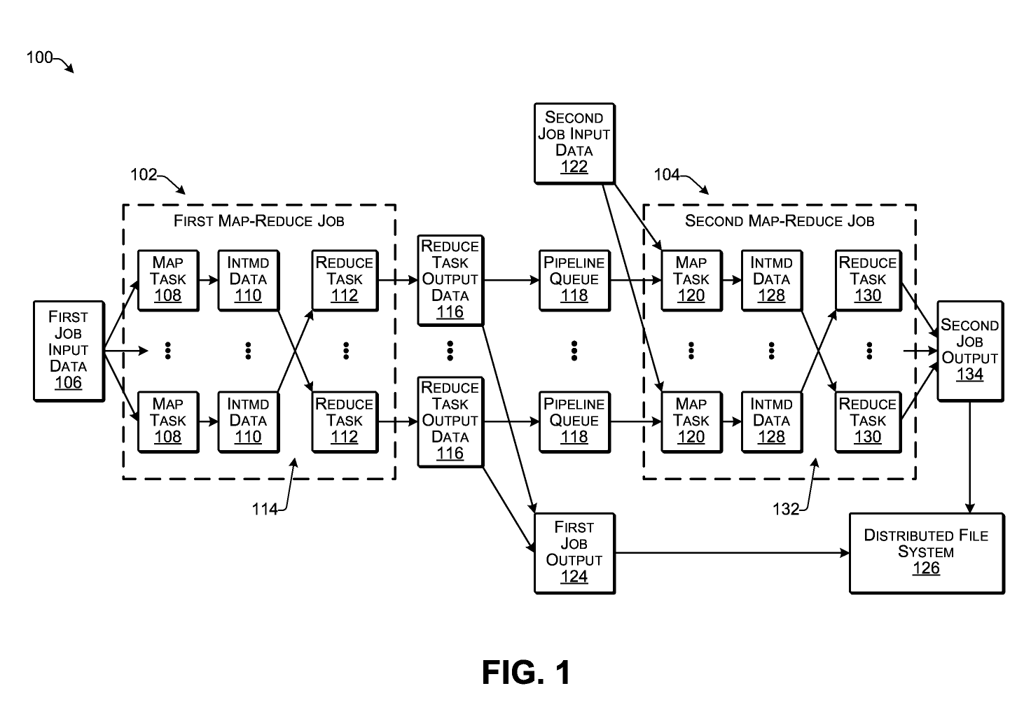

FIG. 1 illustrates an example multiple map-reduce job pipeline execution framework 100 according to some implementations. In this example, a first map-reduce job 102 may be executed contiguously with a second map-reduce job 104, such as to generate outputs for various types of large data sets. As one non-limiting example, the data to be analyzed may relate to a transit system, such as data regarding the relative movements and positions of a plurality of vehicles, e.g., trains, buses, or the like. Further, in some cases, it may be desirable for the large amount of data to be processed within a relatively short period of time, such as within one minute, two minutes, five minutes, or other threshold time, depending on the purpose of the analysis. For instance, the arrival times, departure times, etc., of the vehicles in the transit system at various locations may be determined and coordinated based on the analysis of the data. Further, examples herein are not limited to analyzing data for transit systems, but may include any of numerous types of data analysis and data processing. Several additional non-limiting examples of data analysis that may be performed according to some implementations herein may include hospital patient management, just-in-time manufacturing, air traffic management, data warehouse optimization, information security management, business intelligence, and water leakage control, to name a few.

As mentioned above, the second map-reduce job 104 may be executed contiguously with the first map-reduce job 102, to the extent that at least a portion of the results of the first map-reduce job 102 are used by the second map-reduce job. Further, in some cases, in-memory analytics may be used in processing of the job data to further speed up the data analysis. For instance, in-memory analytics may include querying and/or analyzing data residing in a computer's random access memory (RAM) rather than data stored on physical hard disks. This can result in greatly shortened query response times, thereby allowing business intelligence and data analytic applications to support faster decision making, or the like. Further, while the example of FIG. 1 illustrates pipeline execution of two contiguous map-reduce jobs, other examples may include execution of more than two contiguous map-reduce jobs using similar techniques. Consequently, implementations herein are not limited to execution of any particular number of contiguous map-reduce jobs.

According to the implementations herein, the second job 104 can start execution and use data produced by the first job 102 before processing of the first job 102 has completed. For example, one or more reduce task outputs can be used for the second job, as the reduce task outputs become available, and while the first job is still being processed. Thus, the second job can be set up and can begin processing before the first job completes, thereby reducing the amount of time used for the overall data analysis as compared with merely processing the first job 102 and the second job 104 sequentially.

In the illustrated example, first job input data 106 may be received by the framework 100 for setting up execution of the first job 102. For example, the first job input data 106 may be provided to a plurality of map tasks 108. The map tasks 108 may produce intermediate data 110 that may be delivered to a plurality of reduce tasks 112 of the first map-reduce job 102. In some examples, as indicated at 114, the intermediate data 110 may be shuffled for delivery to respective reduce tasks 112, depending on the nature of the first map-reduce job 102.

The reduce tasks 112 may perform reduce functions on the intermediate data 110 to generate reduce task output data 116. The reduce task output data 116 is delivered to a plurality of pipeline queues 118 that have been set up for providing the reduce task data 116 to the second map-reduce job 104. For example, the pipeline queues 118 may connect to reduce tasks 112, as described additionally below, to receive the reduce task output data 116 as the reduce task output data 118 is generated, and may provide the reduce task output data 116 to respective map tasks 120 of the second map-reduce job 104 while one or more portions of the first map-reduce job 102 are still being processed. As mentioned above, to optimize system resource utilization, there may not be a one-to-one pipeline queue connection between the first reduce tasks 112 and the second map tasks 120. Additionally, in some examples, the second map tasks 120 may also receive second job input data 122.

When the first job has finished processing, e.g., all of the reduce tasks 112 have been completed, first job output 124 may be generated in a desired format and written to a distributed file system 126, in some examples. For instance, the input data and/or the output data for the map-reduce jobs may be stored in a distributed file system, such as the HADOOP® Distributed File System (HDFS), or other suitable distributed file system that may provide locality of data to the computing devices performing the map and reduce operations.

The second map tasks 120 may generate intermediate data 128, which is provided to respective reduce tasks 130 of the second job 104. In some examples, as indicated at 132, the intermediate data 128 may be shuffled for delivery to the respective reduce tasks 130, depending on the nature of the second map-reduce job 104. The reduce tasks 130 may perform reduction of the intermediate data 128 to generate second job output 134 in a desired format, which may be written to the distributed file system 126.

The example of FIG. 1 provides a high-level description of some examples herein to illustrate pipeline connection and processing of contiguous map-reduce jobs 102 and 104. As discussed additionally below, pipeline queue connections for various map tasks or reduce tasks may be created dynamically to enable optimal utilization of system computing resources during the pipeline execution of the map-reduce jobs 102 and 104. Further, in the event of failure of a particular task or pipeline queue, recovery techniques are enabled on a task-level granularity to avoid having to restart an entire map-reduce job.

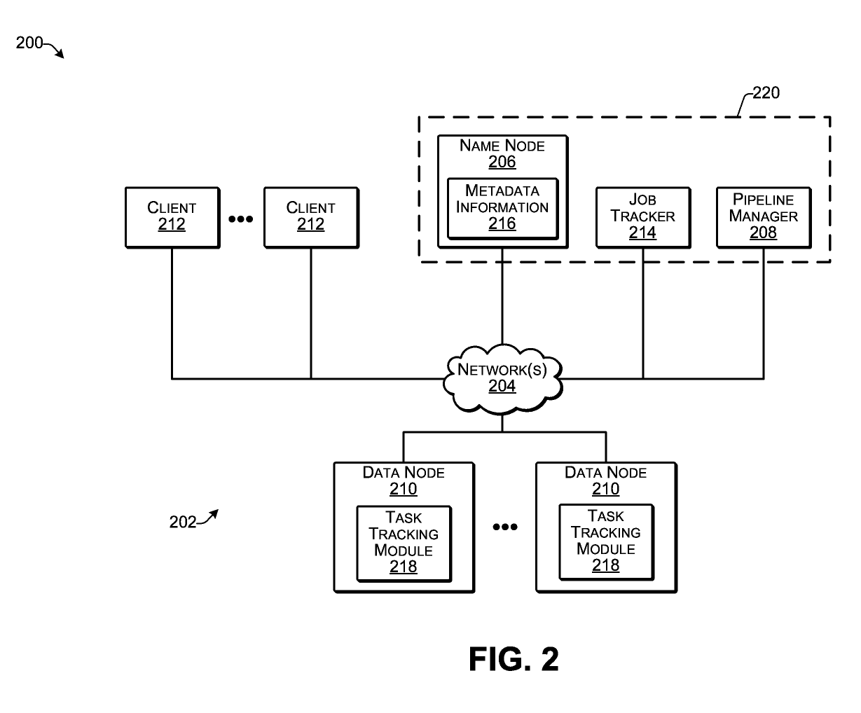

FIG. 2 illustrates an example architecture of a system 200 according to some implementations. The system 200 includes a plurality of computing devices 202 able to communicate with each other over one or more networks 204. The computing devices 202, which may also be referred to herein as nodes, include a name node 206, a pipeline manager 208, a plurality of data nodes 210 (which may also be referred to as a cluster herein), one or more clients 212, and a job tracker 214 connected to the one or more networks 204. The name node 206 may manage metadata information 216 corresponding to data stored in the distributed file system (not shown in FIG. 2) that may provide locality of data to the data nodes 210. The job tracker 214 may receive map-reduce jobs submitted by one or more of the clients 212, and may assign the corresponding map tasks and reduce tasks to be executed at the data nodes 210.

Each data node 210 may include a task tracking module 218, which can monitor the status of map tasks and/or reduce tasks executed at the data node 210. Further, the task tracking module 218 can report the status of the map tasks and/or the reduce tasks of the respective data node 210 to the job tracker 214. The pipeline manager 208 receives pipeline access requests from the clients 212 and data nodes 210. In response, the pipeline manager 208 creates pipeline queues across the data nodes 210, assigns pipeline connections to the data nodes 210, and deletes pipeline queues when no longer needed.

Furthermore, while the job tracker 214, pipeline manager 208, and name node 206 are illustrated as separate nodes in this example, in other cases, as indicated at 220, the functions of some or all of these nodes 214, 208 and/or 206 may be located at the same physical computing device 202. For instance, the name node 206, pipeline manager 208 and/or job tracker 214 may each correspond to one or more modules that may reside on and/or be executed on the same physical computing device 202. As another example, the same physical computing device 202 may have multiple virtual machines configured thereon, e.g., a first virtual machine configured to act as the name node 206, a second virtual machine configured to act as the pipeline manager 208, and/or a third virtual machine configured to act as the job tracker 214. Further, while several example system architectures have been discussed herein, numerous other system architectures will be apparent to those of skill in the art having the benefit of the disclosure herein.

In some examples, the one or more networks 204 may include a local area network (LAN). However, implementations herein are not limited to a LAN, and the one or more networks 204 can include any suitable network, including a wide area network, such as the Internet; an intranet; a wireless network, such as a cellular network, a local wireless network, such as Wi-Fi, and/or close-range wireless communications, such as BLUETOOTH®; a wired network; or any other such network, a direct wired connection, or any combination thereof. Accordingly, the one or more networks 204 may include both wired and/or wireless communication technologies. Components used for such communications can depend at least in part upon the type of network, the environment selected, or both. Protocols for communicating over such networks are well known and will not be discussed herein in detail. Accordingly, the computing devices 202 are able to communicate over the one or more networks 204 using wired or wireless connections, and combinations thereof.

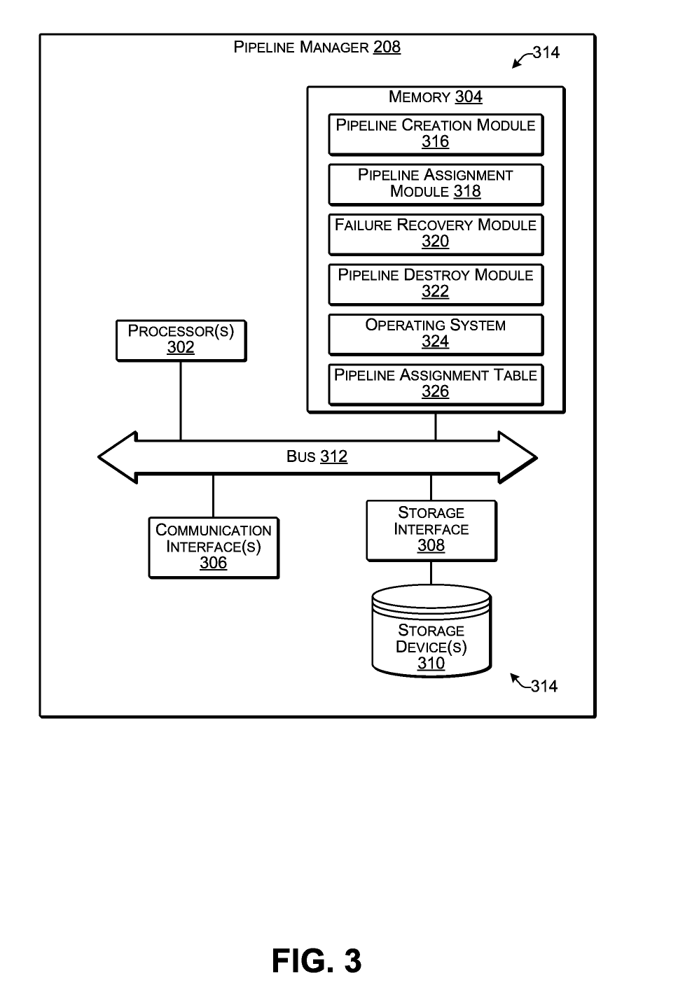

FIG. 3 illustrates select components of an example computing device configured as the pipeline manager 208 according to some implementations. In some examples, the pipeline manager 208 may include one or more servers or other types of computing devices that may be embodied in any number of ways. For instance, in the case of a server, the modules, other functional components, and data storage may be implemented on a single server, a cluster of servers, a server farm or data center, a cloud-hosted computing service, and so forth, although other computer architectures may additionally or alternatively be used. In the illustrated example, the pipeline manager 208 may include, or may have associated therewith, one or more processors 302, a memory 304, one or more communication interfaces 306, a storage interface 308, one or more storage devices 310, and a bus 312.

Each processor 302 may be a single processing unit or a number of processing units, and may include single or multiple computing units or multiple processing cores. The processor(s) 302 can be implemented as one or more central processing units, microprocessors, microcomputers, microcontrollers, digital signal processors, state machines, logic circuitries, and/or any devices that manipulate signals based on operational instructions. For instance, the processor(s) 302 may be one or more hardware processors and/or logic circuits of any suitable type specifically programmed or configured to execute the algorithms and processes described herein. The processor(s) 302 can be configured to fetch and execute computer-readable instructions stored in the memory 304, which can program the processor(s) 302 to perform the functions described herein. Data communicated among the processor(s) 302 and the other illustrated components may be transferred via the bus 312 or other suitable connection.

In some cases, the storage device(s) 310 may be at the same location as the pipeline manager 208, while in other examples, the storage device(s) 310 may be remote from the pipeline manager 208, such as located on the one or more networks 204 described above. The storage interface 308 may provide raw data storage and read/write access to the storage device(s) 310.

The memory 304 and storage device(s) 310 are examples of computer-readable media 314. Such computer-readable media 314 may include volatile and nonvolatile memory and/or removable and non-removable media implemented in any type of technology for storage of information, such as computer-readable instructions, data structures, program modules, or other data. For example, the computer-readable media 314 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the pipeline manager 208, the computer-readable media 314 may be a type of computer-readable storage media and/or may be a tangible non-transitory media to the extent that when mentioned, non-transitory computer-readable media exclude media such as energy, carrier signals, electromagnetic waves, and/or signals per se.

The computer-readable media 314 may be used to store any number of functional components that are executable by the processor(s) 302. In many implementations, these functional components comprise instructions or programs that are executable by the processor(s) 302 and that, when executed, specifically configure the processor(s) 302 to perform the actions attributed herein to the pipeline manager 208. Functional components stored in the computer-readable media 314 may include a pipeline creation module 316, a pipeline assignment module 318, a failure recovery module 320, and a pipeline destroy module 322, which may be one or more computer programs, or portions thereof. As one example, these modules 316-322 may be stored in storage device(s) 310, loaded from the storage device(s) 310 into the memory 304, and executed by the one or more processors 302. Additional functional components stored in the computer-readable media 304 may include an operating system 324 for controlling and managing various functions of the pipeline manager 208.

In addition, the computer-readable media 304 may store data and data structures used for performing the functions and services described herein. Thus, the computer-readable media 314 may store a pipeline assignment table 326, which may be accessed and/or updated by one or more of the modules 316-322. The pipeline manager 208 may also include or maintain other functional components and data, which may include programs, drivers, etc., and the data used or generated by the functional components. Further, the pipeline manager 208 may include many other logical, programmatic and physical components, of which those described above are merely examples that are related to the discussion herein.

The communication interface(s) 306 may include one or more interfaces and hardware components for enabling communication with various other devices, such as over the network(s) 204 discussed above. For example, communication interface(s) 306 may enable communication through one or more of a LAN, the Internet, cable networks, cellular networks, wireless networks (e.g., Wi-Fi) and wired networks, direct connections, as well as close-range communications such as BLUETOOTH®, and the like, as additionally enumerated elsewhere herein.

Further, while the figure illustrates the components and data of the pipeline manager 208 as being present in a single location, these components and data may alternatively be distributed across different computing devices and different locations in any manner. Consequently, the functions may be implemented by one or more computing devices, with the various functionality described above distributed in various ways across the different computing devices. The described functionality may be provided by the servers of a single entity or enterprise, or may be provided by the servers and/or services of multiple different enterprises.

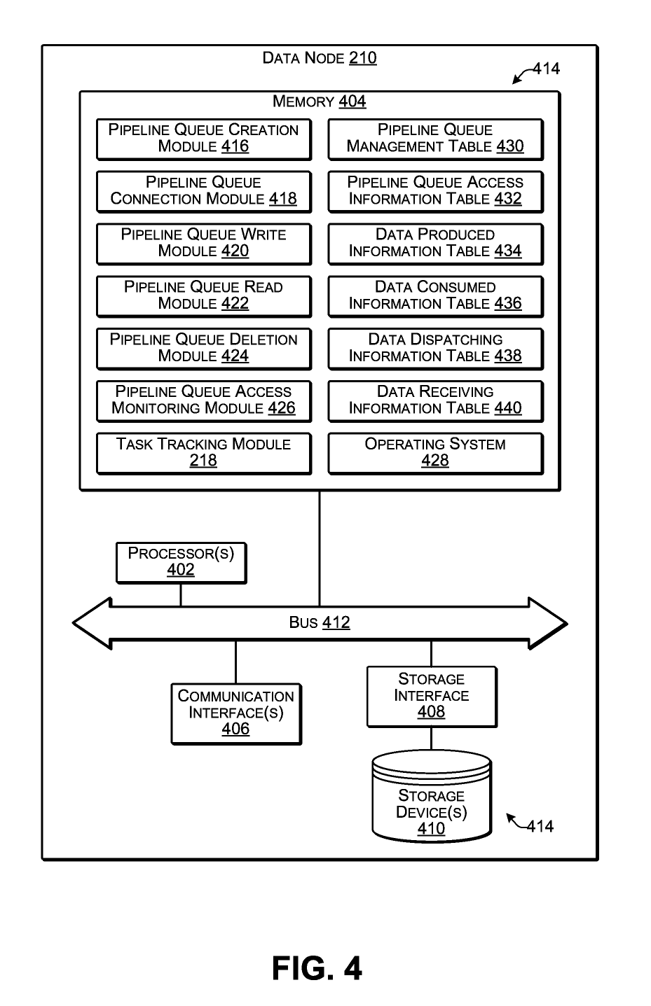

FIG. 4 illustrates select components of an example computing device configured as the data node 210 according to some implementations. In some examples, the data node 210 may include one or more servers or other types of computing devices that may be embodied in any number of ways. For instance, in the case of a server, the modules, other functional components, and data storage may be implemented on a single server, a cluster of servers, a server farm or data center, a cloud-hosted computing service, and so forth, although other computer architectures may additionally or alternatively be used. In the illustrated example, the data node 210 may include, or may have associated therewith, one or more processors 402, a memory 404, one or more communication interfaces 406, a storage interface 408, one or more storage devices 410, and a bus 412.

Each processor 402 may be a single processing unit or a number of processing units, and may include single or multiple computing units or multiple processing cores. The processor(s) 402 can be implemented as one or more central processing units, microprocessors, microcomputers, microcontrollers, digital signal processors, state machines, logic circuitries, and/or any devices that manipulate signals based on operational instructions. For instance, the processor(s) 402 may be one or more hardware processors and/or logic circuits of any suitable type specifically programmed or configured to execute the algorithms and processes described herein. The processor(s) 402 can be configured to fetch and execute computer-readable instructions stored in the memory 404, which can program the processor(s) 402 to perform the functions described herein. Data communicated among the processor(s) 402 and the other illustrated components may be transferred via the bus 412 or other suitable connection.

In some cases, the storage device(s) 410 may be at the same location as the data node 210, while in other examples, the storage device(s) 410 may be remote from the data node 210, such as located on the one or more networks 204 described above. The storage interface 408 may provide raw data storage and read/write access to the storage device(s) 410.

The memory 404 and storage device(s) 410 are examples of computer-readable media 414. Such computer-readable media 414 may include volatile and nonvolatile memory and/or removable and non-removable media implemented in any type of technology for storage of information, such as computer-readable instructions, data structures, program modules, or other data. For example, the computer-readable media 414 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the data node 210, the computer-readable media 414 may be a type of computer-readable storage media and/or may be a tangible non-transitory media to the extent that when mentioned, non-transitory computer-readable media exclude media such as energy, carrier signals, electromagnetic waves, and/or signals per se.

The computer-readable media 414 may be used to store any number of functional components that are executable by the processor(s) 402. In many implementations, these functional components comprise instructions or programs that are executable by the processor(s) 402 and that, when executed, specifically configure the processor(s) 402 to perform the actions attributed herein to the data node 210. Functional components stored in the computer-readable media 414 may include a pipeline queue creation module 416, a pipeline queue connection module 418, a pipeline queue write module 420, a pipeline queue read module 422, a pipeline queue deletion module 424, a pipeline queue access monitoring module 426, and the task tracking module 218, which may be one or more computer programs, or portions thereof. As one example, these modules may be stored in storage device(s) 410, loaded from the storage device(s) 410 into the memory 404, and executed by the one or more processors 402. Additional functional components stored in the computer-readable media 404 may include an operating system 428 for controlling and managing various functions of the data node 210.

In addition, the computer-readable media 404 may store data and data structures used for performing the functions and services described herein. Thus, the computer-readable media 414 may store a pipeline queue management table 430, a pipeline queue access information table 432, a data produced information table 434, a data consumed information table 436, a data dispatching information table 438, and a data receiving information table 440, which may be accessed and/or updated by one or more of the modules 218 and/or 416-426. The data node 210 may also include or maintain other functional components and data, which may include programs, drivers, etc., and the data used or generated by the functional components. Further, the data node 210 may include many other logical, programmatic and physical components, of which those described above are merely examples that are related to the discussion herein.

The communication interface(s) 406 may include one or more interfaces and hardware components for enabling communication with various other devices, such as over the network(s) 204. For example, communication interface(s) 406 may enable communication through one or more of a LAN, the Internet, cable networks, cellular networks, wireless networks (e.g., Wi-Fi) and wired networks, direct connections, as well as close-range communications such as BLUETOOTH®, and the like, as additionally enumerated elsewhere herein.

Further, while FIG. 4 illustrates the components and data of the data node 210 as being present in a single location, these components and data may alternatively be distributed across different computing devices and different locations in any manner. Consequently, the functions may be implemented by one or more computing devices, with the various functionality described above distributed in various ways across the different computing devices. The described functionality may be provided by the servers of a single entity or enterprise, or may be provided by the servers and/or services of multiple different enterprises. Additionally, the other computing devices 202 described above may have hardware configurations similar to those discussed above with respect to the pipeline manager 208 and the data node 210, but with different data and functional components to enable them to perform the various functions discussed herein.

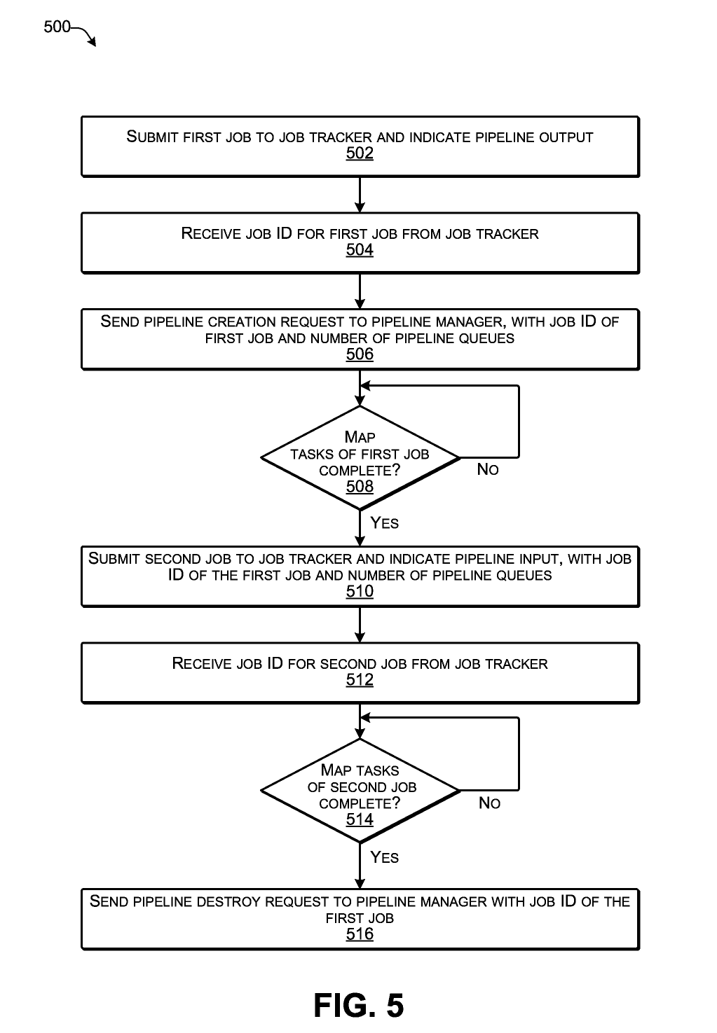

FIGS. 5-7, 10, 12, 13, 18 and 20-23 are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, frameworks and systems described in the examples herein, although the processes may be implemented in a wide variety of other environments, frameworks and systems.

FIG. 5 is a flow diagram illustrating an example process 500 for submitting, from a client, two contiguous map-reduce jobs for pipeline execution according to some implementations.

At 502, a client submits a first map-reduce job (referred to as the first job) to the job tracker 214, and indicates that a pipeline will be used to output results generated by the respective reduce tasks. For example, the first job may include a plurality of map tasks and a plurality of reduce tasks.

At 504, the client receives a job identifier (ID) assigned for the first job. For example, at least in part in response to receiving the first job, the job tracker 214 may assign one or more respective map tasks and reduce tasks to respective ones of the plurality of data nodes 210, which may cause the corresponding data nodes 210 to start to execute the respective map tasks. The job tracker 214 may then return an indication of success to the client with the job ID assigned for the first job.

At 506, the client sends a pipeline creation request to the pipeline manager 208, together with the job ID of the first job and the number of pipeline queues to be created. As one example, the number of pipeline queues may be equal to the number of reduce tasks, which is typically defined in the map-reduce job. In some examples, a pipeline queue may be a FIFO (first-in-first-out) queue created in a memory location on a data node, or at other suitable memory location accessible by the data node. The reduce tasks and the map tasks may be connected to particular pipeline queues using a connection technology, such as TCP/IP (transmission control protocol/Internet protocol) socket connections, other types of socket connections, or other routing technology that, in the case of reduce task output data, directs the data automatically to the pipeline queue, or in the case of map task input data, draws the data from the pipeline queue. For example a socket on a first data node executing a reduce task may connect to a socket on a second node maintaining the pipeline queue for sending the reduce task data to the pipeline queue. Another socket on the second node may connect to a socket on a third node that executes a map task for enabling the map task to receive the task data from the pipeline queue.

At 508, the client determines whether the map tasks of the first job are completed. When the map tasks of the first job are completed, the intermediate data generated by the map tasks may be sent to the respective reduce tasks, such as through a shuffle process. The reduce tasks may then start to execute and write results into pipeline queues created for the first job. Accordingly, the client may wait for the map tasks of the first job to complete before submitting a second map-reduce job.

At 510, when the map tasks of the first map-reduce job are complete, the client submits a second map-reduce job (referred to as the second job) to the job tracker 214, and indicates that pipeline queues will be used to input data for map tasks, with the job ID of the first job and number of pipeline queues created for the first job, through job configuration.

At 512, the client may receive the job ID for the second job. For example, upon receiving the second job, the job tracker 214 may assign the respective map tasks and reduce tasks to respective data nodes 210. In response, the corresponding data nodes 210 may start to execute the map tasks for the second job. In some examples, a dummy InputSplit array may be created having the same number of entries as the number of pipeline queues, so that job tracker 214 can assign the same number of map tasks to the data nodes 210. For instance, in the map-reduce framework herein, the dummy InputSplit array may represent the data to be processed by individual mappers (i.e., nodes that perform mapping tasks). Thus, the dummy InputSplit array, while not containing the actual data to be mapped, enables assignment of mapping tasks to data nodes in advance so that the mapping nodes are ready to process the data for mapping when the data becomes available from the reducers of the first job. The job tracker 214 then returns an indication of success to the client with a job ID assigned for the second job.

At 514, the client determines whether the map tasks of the second job are completed. When the map tasks of the second job are completed, the intermediate data generated by the map tasks may be sent to the respective reduce tasks, such as through a shuffle process. The reduce tasks may then start to execute and write results. If there is a third contiguous map-reduce job to be processed, the results may be written into pipeline queues created for connection between the second job and the third job.

At 516, when the map tasks of the second map-reduce job are complete, the client sends a pipeline destroy request to the pipeline manager 208, with the job ID of the first job since all the data generated from the first job has been consumed successfully by the second job. The pipeline destroy execution is discussed additionally below.

The example process 500 of FIG. 5 illustrates example operations that are performed when two contiguous map-reduce jobs are processed. In other examples, more than two contiguous pipeline map-reduce jobs may be executed using the techniques described herein. For instance, a third map-reduce job may be executed contiguously with the second map-reduce job. In such a case, an additional pipeline creation request (similar to that discussed above with respect to block 506, but with the second job ID) can be sent to the pipeline manager, such as before, during, or after execution of the operations described with respect to blocks 514 and 516. This causes additional pipeline queues to be created for pipeline connection between the output of the second map-reduce job and input of the third map-reduce job. Accordingly, using the arrangements and techniques herein, any number of map-reduce jobs may be executed contiguously in sequence.

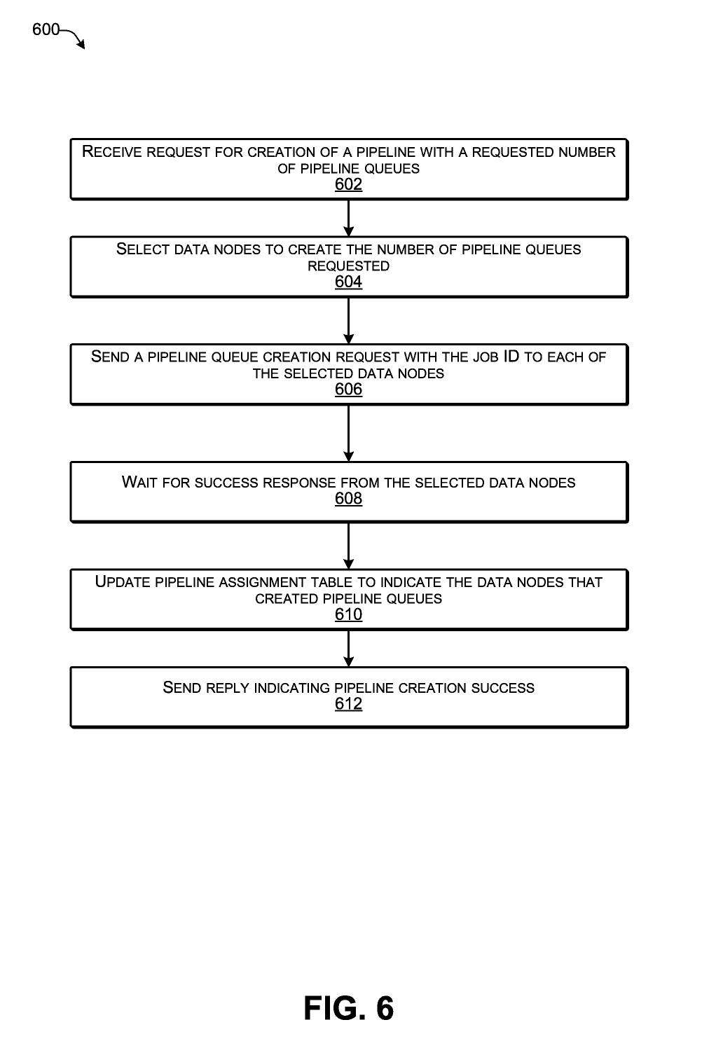

FIG. 6 is a flow diagram illustrating an example process 600 for a pipeline creation request in a pipeline manager 208 according to some implementations. For instance, the process 600 may correspond to execution of the pipeline creation module 316.

At 602, the pipeline manager may receive a pipeline creation request from a client, such as discussed above with respect to block 506 of FIG. 5.

At 604, the pipeline manager may select a plurality of the data nodes to create the number of pipeline queues indicated in the pipeline creation request. For example, the data nodes may be selected based on round robin method or other known technique. In some examples, a single pipeline queue may be created on each of the selected data nodes. In other examples, multiple pipeline queues may be created on at least one of the selected data nodes, e.g., one or more pipeline queues may be created on a first data node, one or more pipeline queues may be created on a second data node, and so forth. Further, in some examples, a pipeline queue may be created on a data node that also executes a map task or a reduce task that connects to the pipeline queue and/or to another pipeline queue.

At 606, the pipeline manager may send a pipeline queue creation request with the job ID to each of the selected data nodes.

At 608, the pipeline manager waits for a success response from the respective data nodes.

At 610, the pipeline manager updates the pipeline assignment table to indicate which data nodes have created pipeline queues for the job.

At 612, the pipeline manager sends an indication of pipeline creation success to the client.

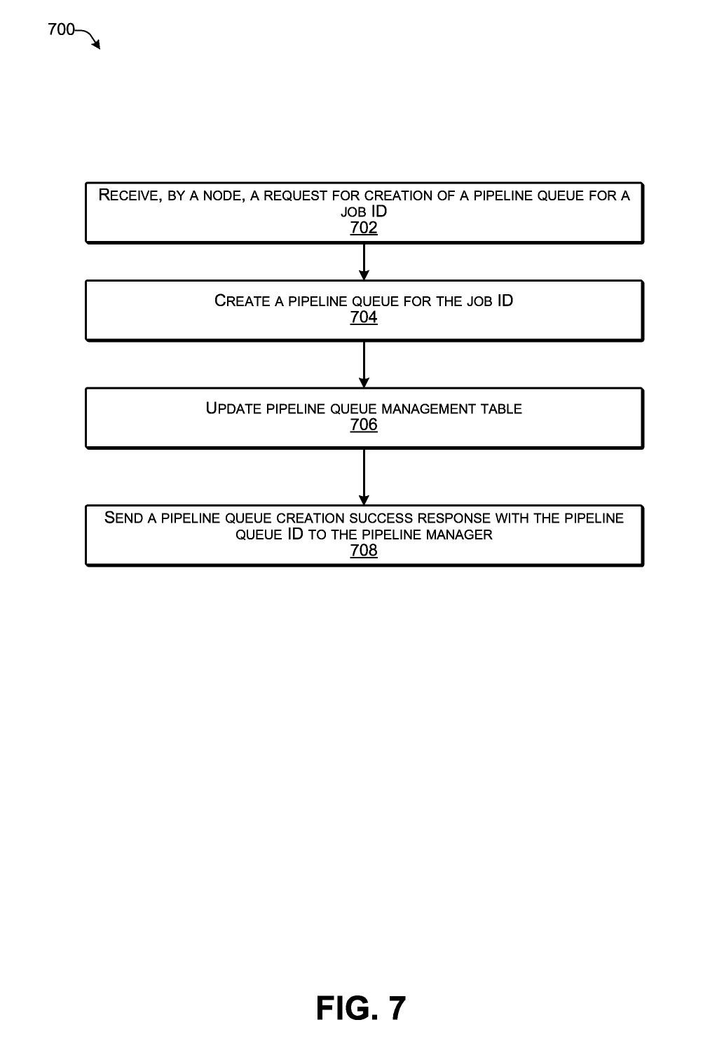

FIG. 7 is a flow diagram illustrating an example process 700 that may be executed by a data node for creating a pipeline queue according to some implementations. For instance, the data node may execute the pipeline queue creation module 416 to create the pipeline queue in response to a request from the pipeline manager.

At 702, the data node receives a pipeline queue creation request from the pipeline manager. For instance, as discussed above, the pipeline manager may receive a job request from a client and may send a plurality of pipeline queue creation requests with a job ID to selected data nodes.

At 704, the data node may create a pipeline queue for the job ID. For instance, the data node may execute the pipeline queue creation module to create the pipeline queue. In some cases, the creation of the pipeline queue includes allocating a memory location in the memory 404 of the data node to serve as the pipeline queue.

At 706, the data node updates the pipeline queue management table 430 to add information about the created pipeline queue.

At 708, the data node sends an indication of pipeline queue creation success to the pipeline manager 208, along with a pipeline queue ID assigned for the pipeline queue that was created. In some examples, only a small amount of data node memory is allocated for a pipeline queue (e.g., 4 MB), so that the memory usage is negligible. The memory size allocated for a created pipeline queue may be preconfigured to a default size by a system administrator or may be specified in a pipeline creation request sent from a client 212 (see FIG. 4) on a per job basis.

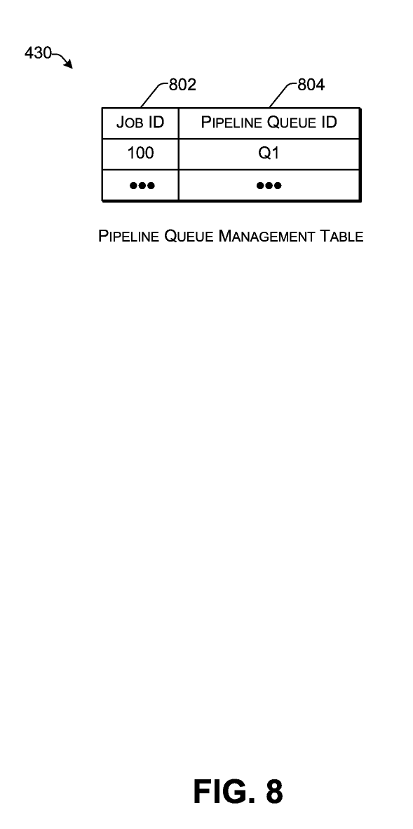

FIG. 8 illustrates an example structure of a pipeline queue management table 430 used by the data node for maintaining information about pipeline queues corresponding to particular jobs according to some implementations. In this example, the pipeline queue management table includes a first column 802 for listing job IDs and a second column 804 for indicating one or more pipeline queues created for the particular job identified by the job ID. In some examples, the job ID 802 may be distinct from other job IDs to serve to individually distinguish a particular map-reduce job from other map-reduce jobs. In some examples, the job IDs are assigned by the job tracker 214 for each map-reduce job requested by a client. The pipeline queue ID 804 may be a distinct ID assigned by a data node 210 for a pipeline queue created at that data node, and may be unique or otherwise individually distinguishable from other pipeline queue IDs used by the data node and/or used within the system 200.

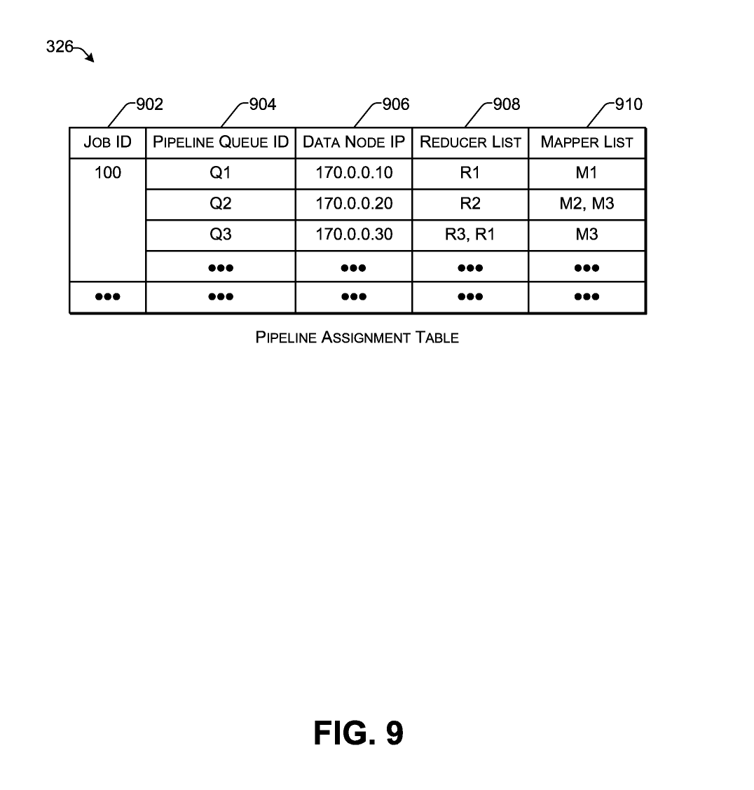

FIG. 9 illustrates an example structure of a pipeline assignment table 326 that may be used by the pipeline manager according to some implementations. As mentioned above with respect to blocks 608 and 610 of FIG. 6, after the pipeline manager receives responses from all the selected data nodes indicating successful creation of their respective pipeline queues, the pipeline manager may update the pipeline assignment table 326. In the illustrated example, the pipeline assignment table 326 includes a plurality of columns for pipeline-related information including a job ID 902, a pipeline queue ID 904, a data node IP 906, a reducer list 908, and a mapper list 910. The job ID 902 may be a distinct ID assigned by a job tracker 214 for a particular map-reduce job that may be unique or otherwise individually distinguishable from other job IDs in the system 200. The pipeline queue ID 904 is a distinct ID assigned by the data node 210 for a particular pipeline queue. The pipeline queue ID 904 may be unique or otherwise individually distinguishable from other pipeline queue IDs used by the data node, and, in some examples, from pipeline queue IDs used by other data nodes in the system 200. The data node IP 906 is the IP address of the data node at which the respective pipeline queue 904 is created. The reducer list 908 is a list of reduce tasks that connect to the respective pipeline queue 904. Similarly, the mapper list 910 is a list of map tasks that connect to the respective pipeline queue 904.

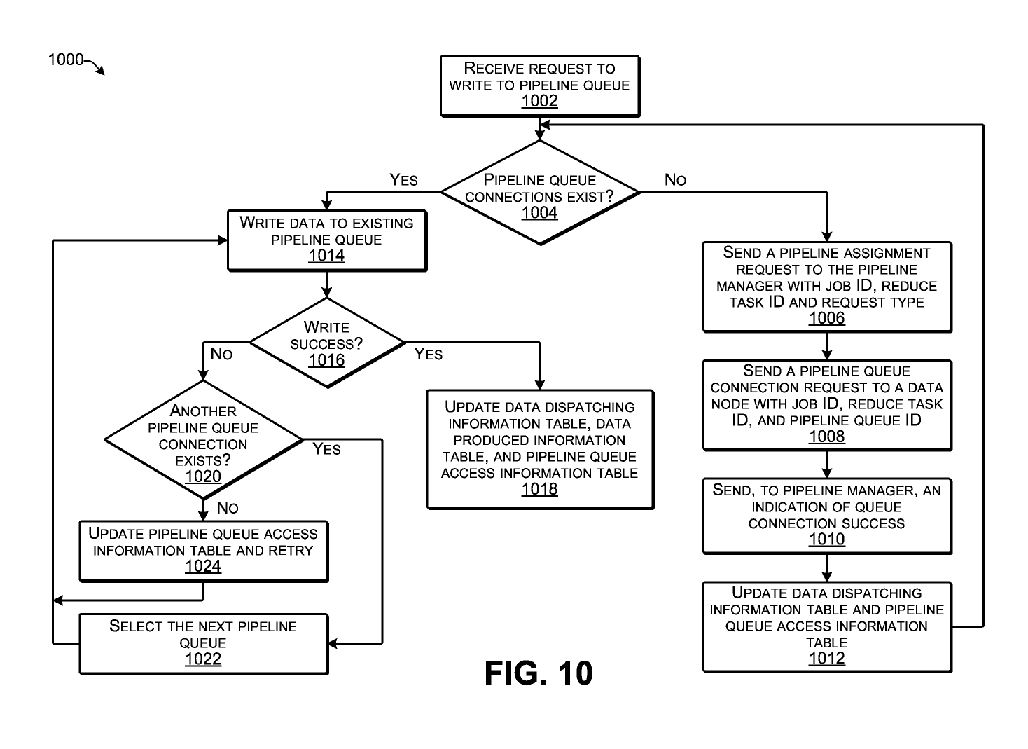

FIG. 10 is a flow diagram illustrating an example process 1000 executed by the pipeline queue write module 420 on the data node for writing to a pipeline queue according to some implementations.

At 1002, the data node receives a request to write to a pipeline queue. As mentioned above with respect to FIG. 5, when the map tasks of the first job are completed, the intermediate data generated by the map tasks is sent to the reduce tasks of the first job through a shuffle process. The reduce tasks will then start to execute and write results into pipeline queues created for the first job.

At 1004, the data node checks whether there are one or more pipeline queues that have been connected for the reduce task. As one example, the data node may conduct a search to determine if there are any relevant entries in the data dispatching information table 438, such as based on the current job ID and reduce task ID.

At 1006, if there are no existing pipeline queue connections, the data node sends a pipeline assignment request to the pipeline manager, with the job ID and reduce task ID, and indicates the request type as “initial”.

At 1008, the data node sends a pipeline queue connection request to the data node that created the pipeline queue with the pipeline queue ID, received in block 1006, as well as the job ID and reduce task ID.

At 1010, the data node sends, to the pipeline manager, an indication of successful pipeline queue connection.

At 1012, the data node updates the data dispatching information table 438 by adding an entry with the corresponding job ID, reduce task ID, pipeline queue ID, and an empty byte range array. The data node also updates the pipeline queue access information table 432.

At 1014, if there is a pipeline queue connected for the reduce task, the data node writes data to the pipeline queue. If there are multiple pipeline queues connected for the reduce task, the data node may randomly select a pipeline queue to which to write the data. Further, the data written to the pipeline queue may also be written to the distributed file system. For example, each reduce task may have a corresponding file in the distributed file system, which may be located at the data node where the reduce task is executed, for receiving the reduce task data. Storing the reduce task results in a file enables the reduce task results to be used by other analysis processes. The reduce task results written to the distributed file system may also be used for failure recovery, as discussed additionally below.

At 1016, the data node checks whether the write operation to the pipeline queue is successful.

At 1018, if the write operation is successful, the data node may update the data dispatching information table 438 by adding the byte range written to the pipeline queue into a corresponding byte range array. The data node also may update the pipeline queue access information table 432 by increasing the corresponding number of accesses by one. Thus, when data is written to a pipeline queue, the data node, at which the pipeline queue is created, will also update the data produced information table 434, by adding the byte range written by the reduce task into the corresponding byte range array.

At 1020, if the write operation is not successful, e.g., due to the pipeline queue being full, then the data node may further check whether there is another pipeline queue connection for receiving the reduce task results.

At 1022, when there is another pipeline queue connection for receiving the reduce task results, the data node selects the next pipeline queue and repeats the process from block 1014.

At 1024, when there is not another pipeline queue connection for the reduce task, the data node updates the pipeline queue access information table 432 by increasing the corresponding number of attempts by one. The data node then retries to write the data to a pipeline queue. In some instances, the starting pipeline queue may be different from the last try if there are multiple pipeline queue connections for the reduce task.

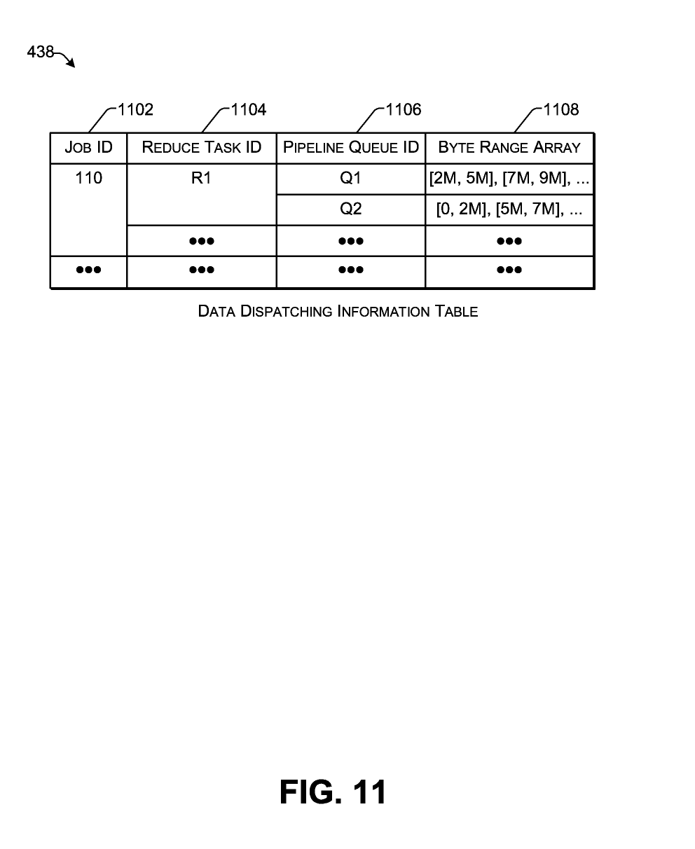

FIG. 11 illustrates an example structure of a data dispatching information table 438 according to some implementations. In the illustrated example, the data dispatching information table 438 includes a plurality of columns containing information that includes a job ID 1102, a reduce task ID 1104, a pipeline queue ID 1106, and a byte range array 1108. The job ID 1102 is a distinct ID assigned by the job tracker 214 for a map-reduce job. The job ID 1102 may be unique or otherwise individually distinguishable from other job IDs used by the job tracker in the system 200. The reduce task ID 1104 is a distinct ID assigned by the job tracker for a reduce task. The reduce task ID 1104 may be unique or otherwise individually distinguishable from other reduce task IDs 1104 assigned by the job tracker in the system 200. The pipeline queue ID 1106 is a distinct ID assigned for a pipeline queue by a data node 210 when the pipeline queue is created. The byte range array 1108 may be an array capturing the byte ranges, e.g., [starting byte offset, ending byte offset], that is written to the pipeline queue 1106 by the corresponding reduce task 1104.

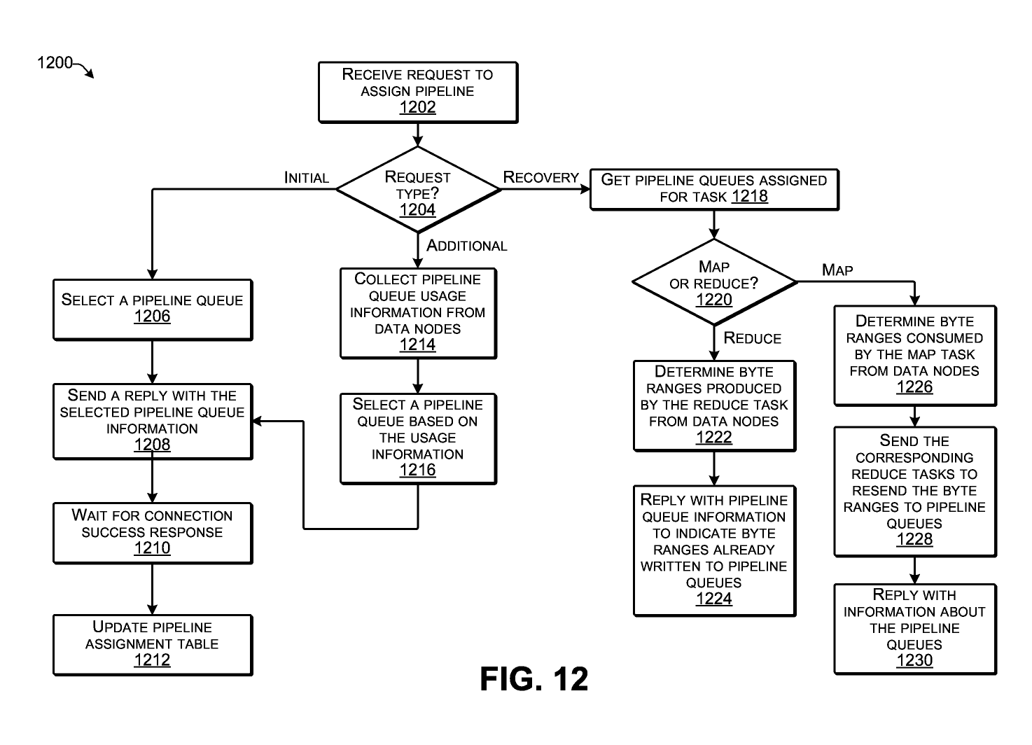

FIG. 12 is a flow diagram illustrating an example process 1200 for pipeline assignment according to some implementations. For instance, the process 1200 may correspond to execution of the pipeline assignment module 318, by the pipeline manager 208, such as in response to receiving a pipeline assignment request from a data node.

At 1202, the pipeline manager receives a request for map-reduce job pipeline, such as from a client.

At 1204, the pipeline manager checks the request type to determine whether the request is an initial request, an additional request, or a recovery request.

At 1206, in response to determining that the request is an initial connection request from the task, the pipeline manager selects a pipeline queue of the job ID. In some examples, a round robin mechanism may be used to select a pipeline queue. Thus, for all reduce tasks or map tasks, a different pipeline queue may be assigned for the initial connection.

At 1208, the pipeline manager may send a reply including information about the selected pipeline queue to the data node. For instance, the reply may indicate the pipeline queue ID 904 and data node IP 906 from the pipeline assignment table 326.

At 1210, the pipeline manager may wait for a connection success response from the data node.

At 1212, after receiving the connection success response from the data node, the pipeline manager may update the pipeline assignment table 326, by adding the task ID into the reducer list (for a reduce task) or to the mapper list (for a map task).

At 1214, if the request received at 1204 is an additional connection request from the task, the pipeline manager collects the pipeline queue usage information (e.g., the amount of data in the pipeline queues, referred to as queue length) from all the data nodes at which the pipeline queues of the job ID have been created.

At 1216, the pipeline manager may select a pipeline queue based on the usage information collected. For example, the pipeline manager may select a pipeline queue with the shortest queue length for a reduce task, or a pipeline queue with longest queue length for a map task. The pipeline manager may then execute operations 1208-1212, to create a new pipeline queue connection for the task. In some cases, a threshold may be configured or preconfigured to the maximum number of pipeline queues to which a map task or reduce task can connect.

At 1218, if the request received at 1204 is a recovery connection request, the pipeline manager may check the pipeline assignment table 326 to get the pipeline queues assigned for the task. For example, if a reduce task or a map task fails, the task may be rescheduled. When a rescheduled reduce task is ready to write data into a pipeline queue, the reduce task data node may send a pipeline assignment request to the pipeline manager, and may indicate the request type as “recovery”. Similarly, when a rescheduled map task is ready to read data from a pipeline queue, the map task data node may send a pipeline assignment request to the pipeline manager, and may indicate the request type as “recovery”.

At 1220, the pipeline manager may check whether the task is a map task or a reduce task.

At 1222, if the task is a reduce task at 1220, the pipeline manager determines byte ranges produced by the reduce task from the data nodes that maintain one or more pipeline queues that were previously connected to the failed reduce task.

At 1224, the pipeline manager sends a reply with information about the one or more pipeline queues previously assigned to the reduce task. For example, the pipeline manager may provide information regarding the byte ranges that have already been written to the pipeline queues so that the rescheduled reduce task will not write this data to the one or more pipeline queues again.

At 1226, if the task is a map task at 1220, the pipeline manager determines the byte ranges already consumed by the failed map task from the data nodes that maintain one or more pipeline queues that were previously connected to the failed map task.

At 1228, the pipeline manager may inform the corresponding reduce tasks to resend the byte ranges, determined at 1226, to the pipeline queues. For example, the reduce task data written to the distributed file system, e.g., as described at block 1014 of FIG. 10 above, may be used to resend the reduce data to a pipeline to aid in recovery of a failed map task or pipeline queue, without having to recompute the lost data. Thus, the reduce task can retrieve the requested byte ranges from a file in the distributed file system and can send this information to the one or more connected pipeline queues.

At 1230, pipeline manager may send a reply to the map task data node with information about the pipeline queues previously assigned to the map task.

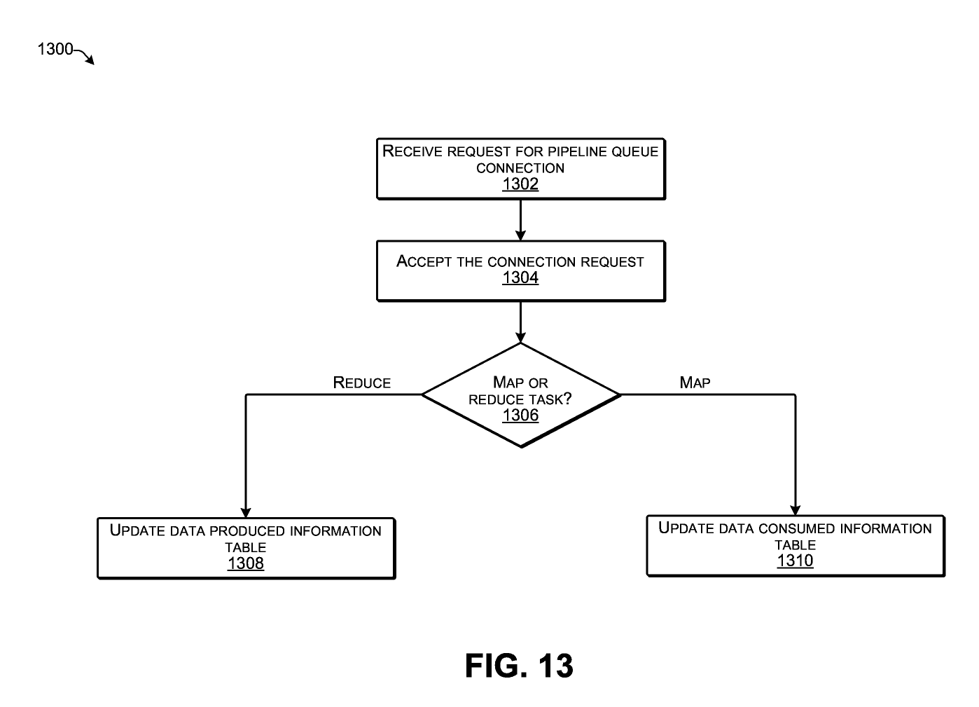

FIG. 13 is a flow diagram illustrating an example process 1300 for pipeline queue connection according to some implementations. For instance, the process 1300 may correspond to execution of the pipeline queue connection module 418 that may be executed by a data node 210, such as in response to receiving a pipeline queue connection request from another data node.

At 1302, the data node may receive a pipeline queue connection request, such as from another data node.

At 1304, the data node accepts the connection request.

At 1306, the data node determines whether the request is from a map task or a reduce task.

At 1308, if the request is from a reduce task, the data node updates the data produced information table 434.

At 1310, alternatively, if the request is from a map task, the data node then updates a data consumed information table 436.

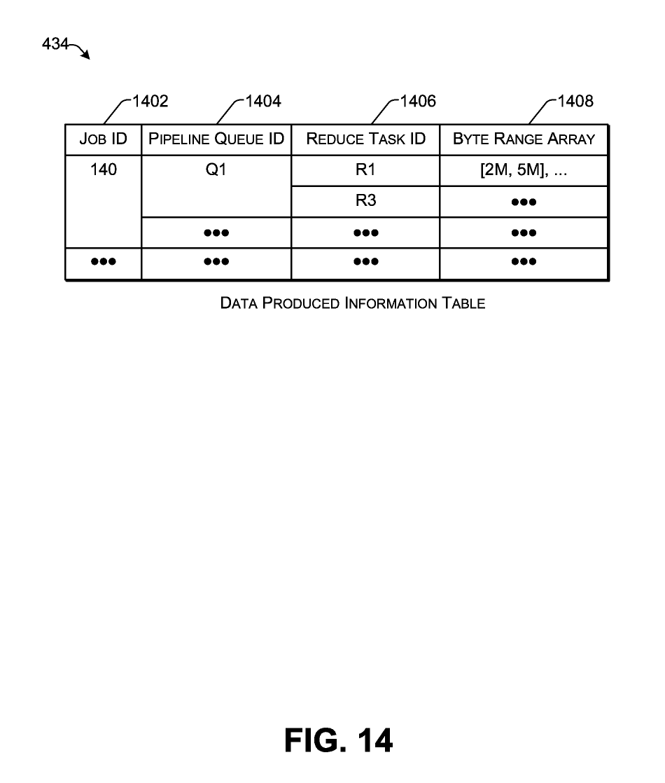

FIG. 14 illustrates an example structure of the data produced information table 434 according to some implementations. In this example, the data produced information table 434 includes a plurality of columns containing information that includes a job ID 1402, a pipeline queue ID 1404, a reduce task ID 1406, and a byte range array 1408. The byte range array 1408 may indicate the data (in byte ranges) written by the corresponding reduce task 1406. For instance, when the data produced information table 434 is updated at block 1308 of FIG. 13 discussed above, a new entry may be added with the corresponding job ID 1402, pipeline queue ID 1404, reduce task ID 1406, and an empty byte range array 1408.

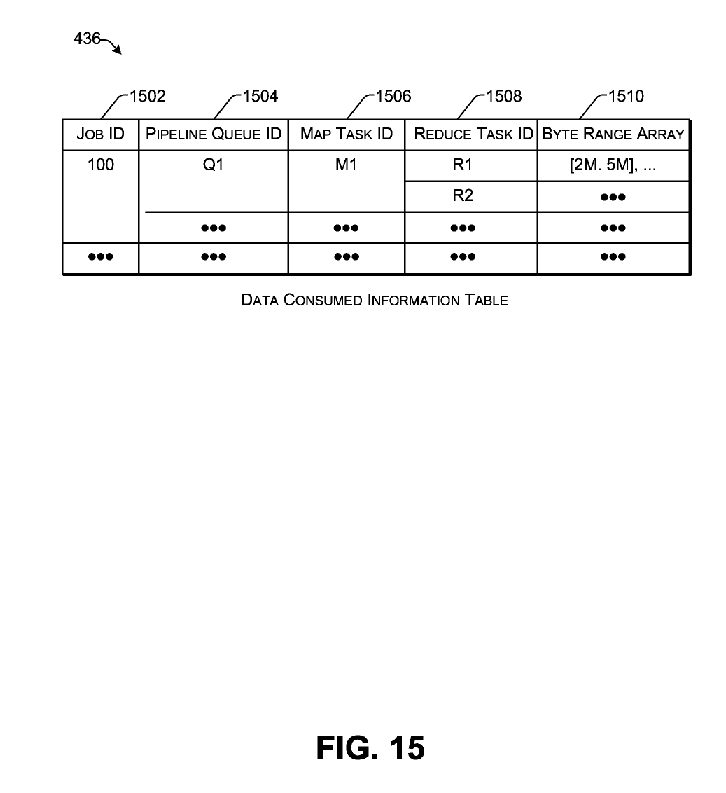

FIG. 15 illustrates an example structure of a data consumed information table 436 according to some implementations. In this example, the data consumed information table 436 includes a plurality of columns containing information that includes a job ID 1502, a pipeline queue ID 1504, a map task ID 1506, a reduce task ID 1508, and a byte range array 1510. For instance, the byte range array 1510 may indicate the data (in byte ranges, produced by the respective reduce task identified at 1508) read by the respective map task identified at 1506. Thus, when the data consumed information table 436 is updated at block 1310 of FIG. 13 discussed above, a new entry may be added with the corresponding job ID 1502, pipeline queue ID 1504, map task ID 1506, an empty reduce task ID 1508, and an empty byte arrange array 1510.

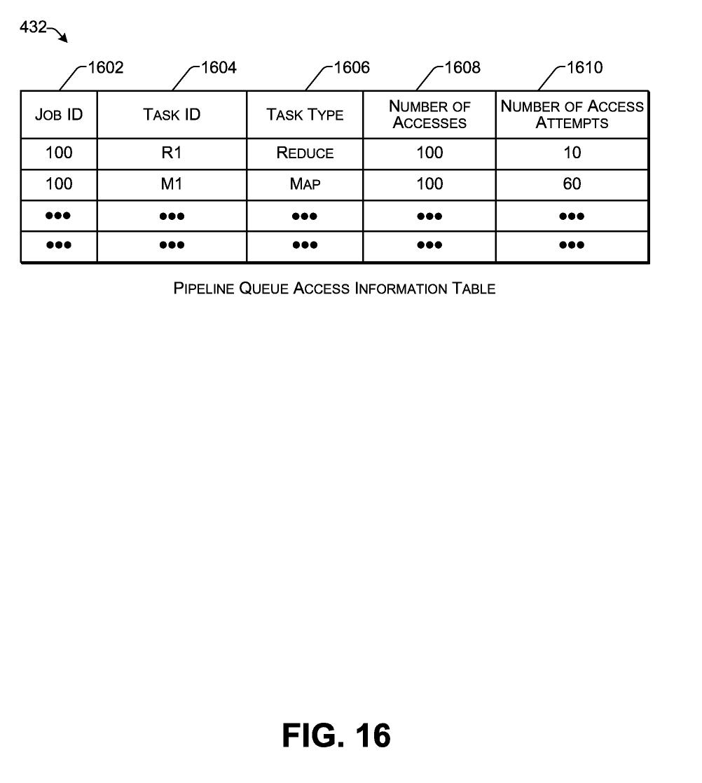

FIG. 16 illustrates an example structure of the pipeline queue access information table 432 according to some implementations. In this example, the pipeline queue access information table 432 includes a plurality of columns containing information that includes a job ID 1602, a task ID 1604, a task type 1606 (e.g., either “Map” or “Reduce”), a number of accesses 1608, and a number of attempts 1610. For instance, the job ID 1602 for a map task is the job ID of the prior map-reduce job. The number of accesses 1608 is the number of write/read accesses to the pipeline queue that are successful. The number of access attempts 1610 is the number of write/read accesses attempts to the pipeline queue that are not successful (e.g., due to the respective pipeline queues being full for a reduce task, or due to the respective pipeline queues being empty for a map task). For example, when the pipeline queue access information table 432 is updated at block 1012 of FIG. 10 discussed above, a new entry may be added with the corresponding job ID 1602, task ID 1604, task type 1606 as “reduce”, a number of accesses 1608 as “0”, and number of access attempts 1610 as “0”.

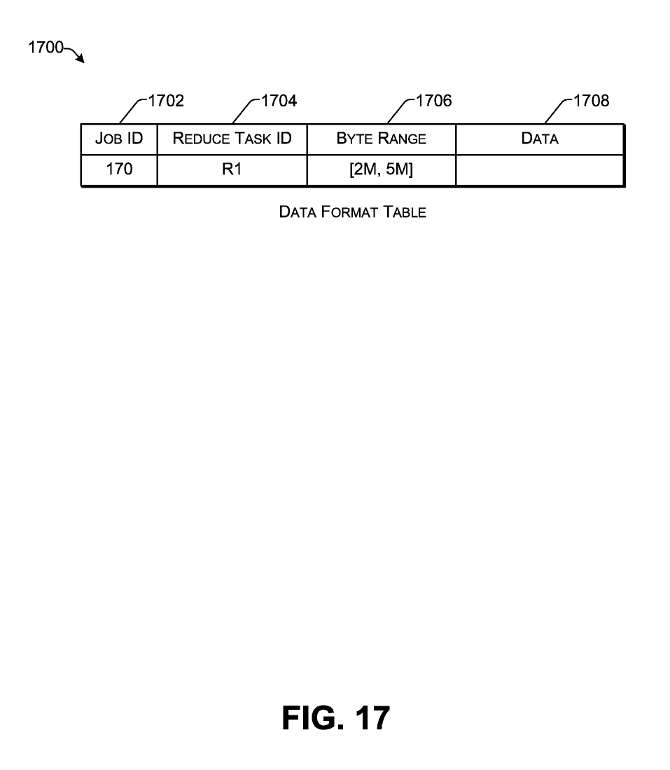

FIG. 17 illustrates an example structure of a data format table 1700 according to some implementations. The data format table 1700 indicates the format of data written to or read from a pipeline queue. The data format table 1700 includes a plurality of columns containing information that includes a job ID 1702, a reduce task ID 1704, a byte range 1706, and the data 1708. For instance, the data 1708 may also be written to the distributed file system (e.g., one file per reduce task, which may be located at the data node where the reduce task is executed). As one example, in a HADOOP® map-reduce framework, the data 1708 may be written to the HDFS so that the data results can be used by other analysis processes. Further, in some cases, the data results written to the distributed file system may be used for failure recovery as discussed additionally below.

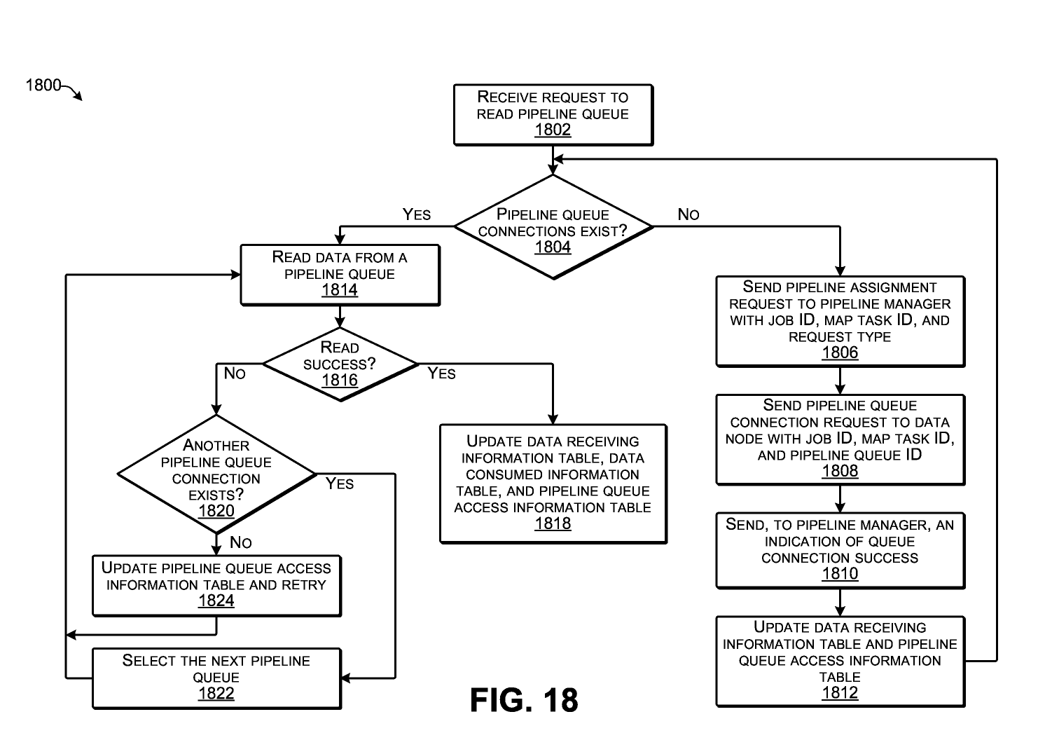

FIG. 18 is a flow diagram illustrating an example process 1800 for performing a pipeline queue read according to some implementations. For example, after the reduce tasks of the first map-reduce job have written data to the respective pipeline queues, the map tasks of the second map-reduce job can then read data from the pipeline queues for computation. The process 1800 may correspond to execution of the pipeline queue read module 422 by a data node 210.

At 1802, the data node receives an indication that the reduce tasks of the first job have written data to the respective pipeline queues.

At 1804, the data node checks whether there are pipeline queues that have been connected for the map task of the second job, by searching entries in the data receiving information table 440 with the current job ID (i.e., the ID of the second job) and the map task ID.

At 1806, if a pipeline queue connection is not found at 1804, the data node sends a pipeline assignment request to the pipeline manager 208. For example, the pipeline assignment request may include the job ID of the first job and the map task ID. Further, the request may indicate the request type as “initial”. In response, the pipeline manager may assign a pipeline queue for the map task as discussed above with respect to FIG. 12 and send the pipeline queue ID to the data node.

At 1808, the data node may receive the pipeline queue ID and send the received pipeline queue ID with a pipeline queue connection request to the data node, along with the job ID of the first job and map task ID.

At 1810, after the connection is established, as discussed above with respect to FIG. 13, the data node may send an indication of pipeline queue connection success to the pipeline manager.

At 1812, the data node updates the data receiving information table 440 by adding an entry with the corresponding job IDs, map task ID, reduce task ID, pipeline queue ID, and an empty byte range array. The data node may also update the pipeline queue access information table 432, by adding an entry with corresponding job ID 1602, task ID 1604, task type 1606 as “Map”, number of accesses 1608 as “0”, and number of access attempts 1610 as “0”.

At 1814, alternatively, if a pipeline queue connection already exists at 1804, the data node may read data from the pipeline queue. Further, if there are multiple pipeline queues connected for the map task, the data node may randomly select one of the multiple pipeline queues.

At 1816, the data node determines whether the read operation from the data queue is successful.

At 1818, if the read operation is successful, the data node may update the data receiving information table 440, by adding the byte range (generated by a reduce task) read from the pipeline queue into the corresponding byte range array, as discussed additionally below. The data node may also update the pipeline queue access information table 432 (discussed above with respect to FIG. 16) by increasing the corresponding number of accesses 1608 by 1. In some examples, when data is read from a pipeline, the data node, at which the pipeline queue is created, will also update the data consumed information table 436 by adding the byte range (generated by a reduce task indicated at 1508) read by the map task into the corresponding byte range array 1510 (see FIG. 15).

At 1820, if the read attempt is not successful at 1816 (e.g., due to the pipeline queue being empty), the data node determines whether there is another pipeline queue connection for the map task.

At 1822, if there is another pipeline queue connection for the map task, the data node selects the next pipeline queue and repeats the process from block 1814.

At 1824, on the other hand, if there is not another pipeline queue connection, the data node updates the pipeline queue access information table 432 by increasing the corresponding number of access attempts 1610 by 1. The data node may then retry reading the data from a pipeline queue. The starting pipeline queue for the subsequent attempt may be different from the previous attempt if there are multiple pipeline queue connections for the particular map task.

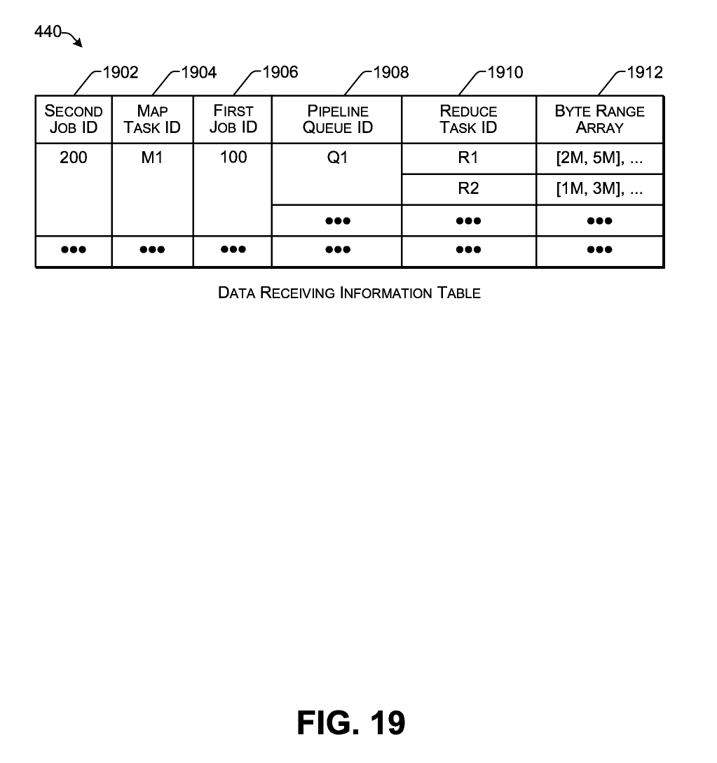

FIG. 19 illustrates an example structure of the data receiving information table 440 according to some implementations. In this example, the data receiving information table 440 includes a plurality of columns containing information that includes a second job ID 1902, a map task ID 1904, a first job ID 1906, a pipeline queue ID 1908, a reduce task ID 1910, and a byte range array 1912. The first job ID 1906 and the second job ID 1902 are distinct IDs for the first map-reduce job and the second map-reduce job of two contiguous map-reduce jobs. The map task ID 1904 is a distinct ID for a map task of the second job identified at 1902. The pipeline queue ID 1908 is a distinct ID for a pipeline queue of the first job identified at 1906. The reduce task ID 1910 is a distinct ID for a reduce task of the first job that writes data to the pipeline queue indicated at 1908 and read by the map task identified at 1904. The byte range array 1912 is an array capturing the byte ranges read from the pipeline queue identified at 1908 produced by the reduce task identified at 1910.

With the aforementioned processes, in-memory pipeline queues can be created between two contiguous map-reduce jobs, for pipeline execution. Reduce tasks of a first map-reduce job can write computation results to the pipeline queues, and the map tasks of the second map-reduce job can read directly the computation results of the first job from the pipeline queues without waiting for the first job to complete.

Typically, in a map-reduce cluster, the computation workload is imbalanced since some map-reduce tasks use more computation capacity than other tasks. Further, the computation capacity of data nodes where the map-reduce tasks are executed may change dynamically, e.g., due to a new job being submitted or an existing job being completed. Accordingly, to maximize utilization of system resources under such dynamic conditions, during the pipeline execution, each data node may execute periodically the pipeline queue access monitoring module 426, e.g., at a suitable time interval, such as every 10 seconds, for example. Based at least in part on the output(s) of the pipeline queue access monitoring module(s) 426 at each data node, additional pipeline queue connections may be assigned to reduce tasks or map tasks which produce or consume data faster than other reduce tasks or map tasks. Consequently, utilization of the resources in the cluster can be optimized and/or utilized more completely than would otherwise be the case.

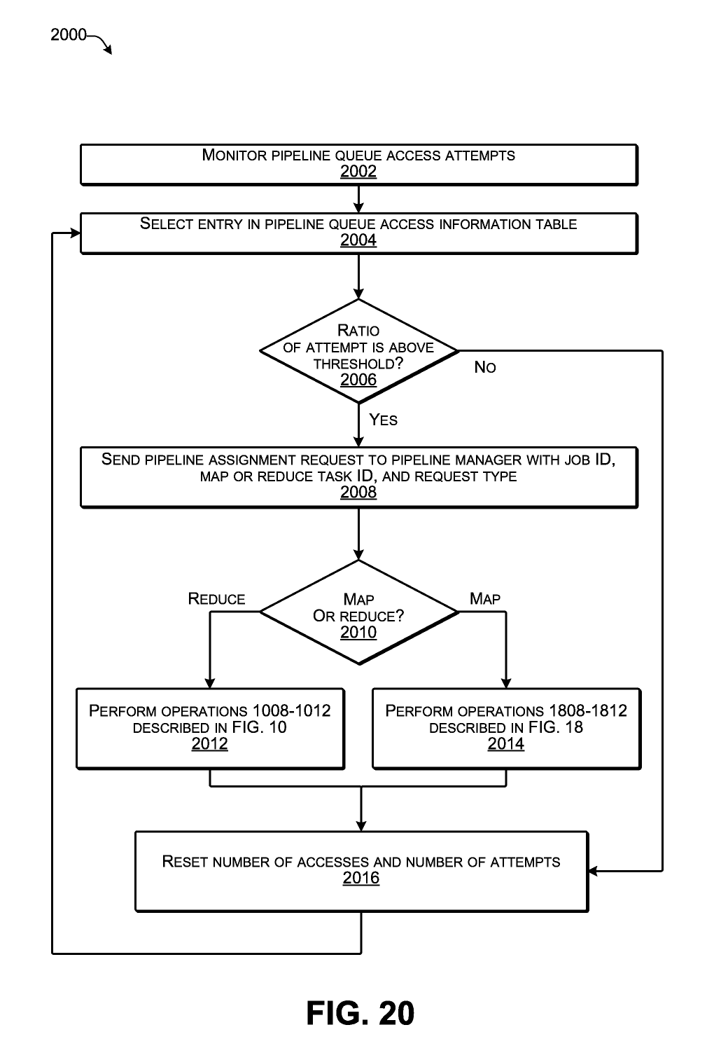

FIG. 20 is a flow diagram illustrating an example process 2000 for pipeline queue access monitoring according to some implementations. The process 2000 may correspond, at least in part, to execution of the pipeline queue access monitoring module 426 by a data node 210. As mentioned above, the pipeline queue access monitoring module 426 may be executed periodically on each data node 210, such as every second, every five seconds, every ten seconds, or other suitable interval.

At 2002, the pipeline queue access monitoring module 426 monitors the pipeline queue accesses and access attempts by the data node.

At 2004, the monitoring module 426 may monitor the access attempts for each entry in the pipeline queue access information table 432 for the data node. As one example, for each entry, the monitoring module 426 may determine whether a ratio of the number of access attempts 1610 over the number of successful accesses 1608 is above a first threshold.

At 2006, for a selected entry the monitoring module 426 determines whether the ratio is above the threshold.

At 2008, if the ratio is above the threshold, the data node sends a pipeline assignment request to the pipeline manager 208. For instance, the data node may send a job ID, map task ID or reduce task ID, and request type (e.g., “additional”) with the pipeline assignment request.

At 2010, after receiving a reply from pipeline manager 208, the data node determines whether the task type 1606 for the entry in the pipeline queue access information table 432 is a map task or a reduce task.

At 2012, for a reduce task, the data node may perform the operations associated with blocks 1008-1012 described above with reference to FIG. 10. For example, the data node may send a pipeline queue connection request to the data node with the pipeline queue ID, along with the job ID and reduce task ID. Further, the data node may send, to the pipeline manager, and indication of successful pipeline queue connection. Additionally, the data node may update the data dispatching information table 438 by adding an entry with the corresponding job ID, reduce task ID, pipeline queue ID, and an empty byte range array. The data node may also update the pipeline queue access information table 432.

At 2014, on the other hand, if the entry is for a map task, the data node may perform the operations 1808-1812 described above with reference to FIG. 18. For instance, the data node may receive the pipeline queue ID and send the received pipeline queue ID with a pipeline queue connection request to the data node, along with the job ID of the first job and map task ID. Further, after the connection is established, the data node may send an indication of pipeline queue connection success to the pipeline manager. In addition, the data node may update the data receiving information table 440 by adding an entry with the corresponding job IDs, map task ID, reduce task ID, pipeline queue ID, and an empty byte range array. The data node may also update the pipeline queue access information table 432, by adding an entry with corresponding job ID 1602, task ID 1604, task type 1606 as “Map”, number of accesses 1608 as “0”, and number of access attempts 1610 as “0”.

At 2016, the data node may reset the number of successful accesses 1608 and the number of access attempts 1610 to “0” for the selected entry. The data node may repeat blocks 2006-2016 for each entry in the data node's pipeline queue access information table 432 on a periodic basis.

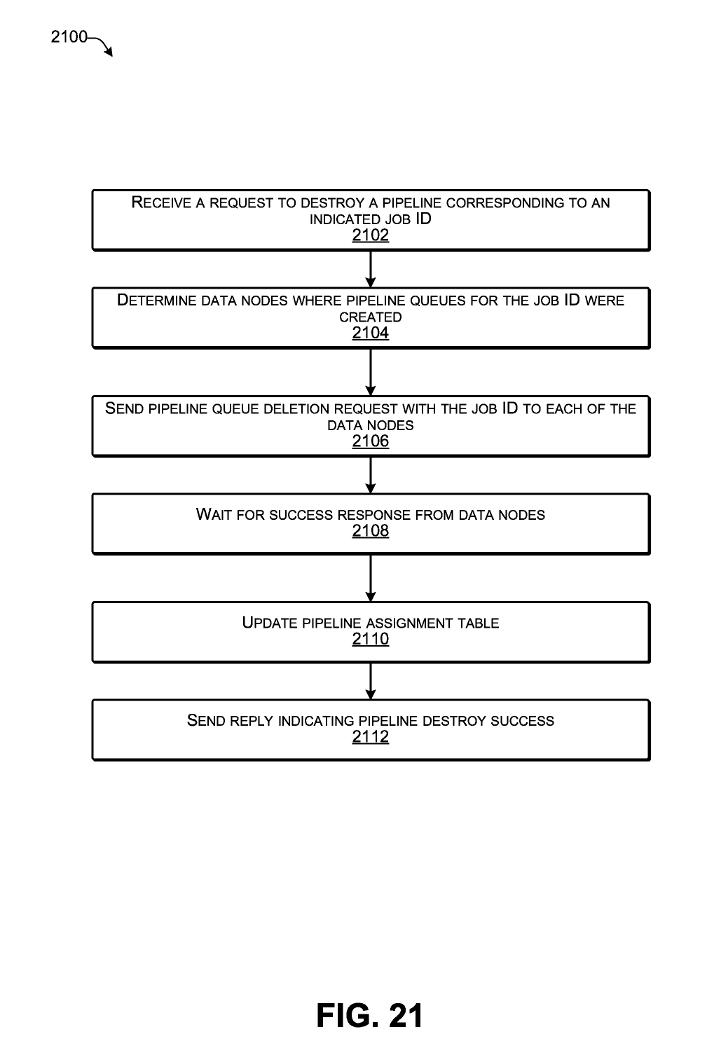

FIG. 21 is a flow diagram illustrating an example process 2100 for destroying a pipeline according to some implementations. The process 2100 may correspond, at least in part, to execution of the pipeline destroy module 322 by the pipeline manager 208.

At 2102, the pipeline manager may receive, from a client, a pipeline destroy request. For example, as discussed above with respect to FIG. 5, at block 514, the client waits for the map tasks of the second job to complete, and at block 516, after the map tasks for the second job have completed, the client sends a pipeline destroy request to the pipeline manager 208 with the job ID of the first job.

At 2104, the pipeline manager searches the pipeline assignment table 326 to determine all the data nodes 210 at which pipeline queues for the job ID of the first job were created.

At 2106, the pipeline manager sends a pipeline queue delete request with the job ID to each of the data nodes found at block 2104.

At 2108, the pipeline manager waits for responses from the found data nodes indicating successful destruction of the respective pipeline queues.

At 2110, the pipeline manager updates the pipeline assignment table 326 to indicate destruction of the corresponding pipeline.

At 2112, the pipeline manager sends, to the client, a reply indicating the particular pipeline has been successfully destroyed.

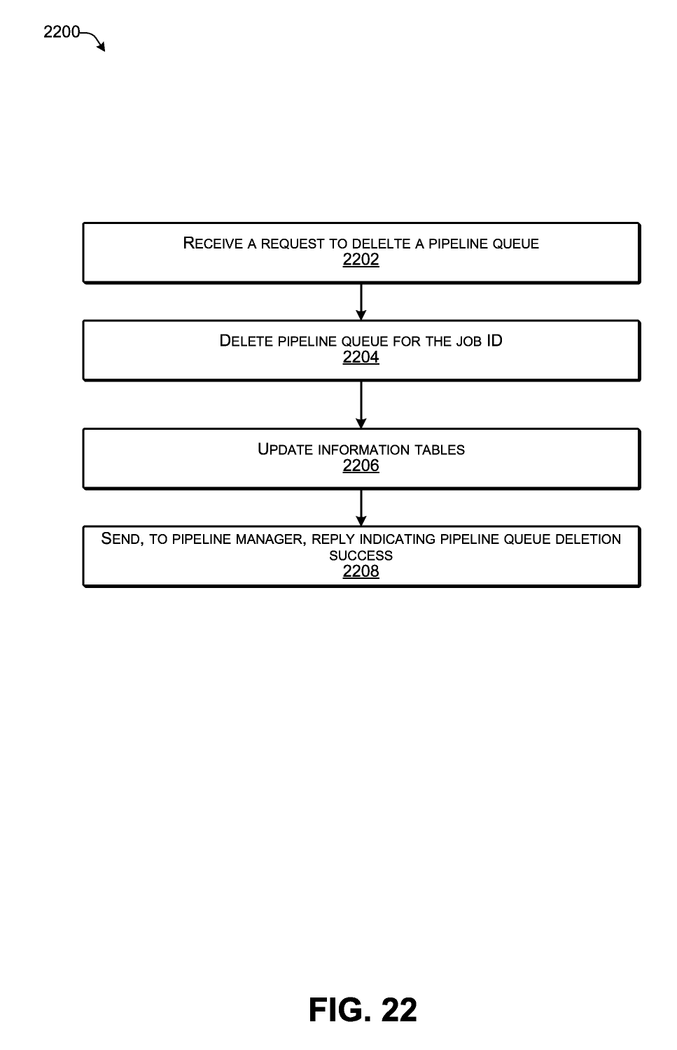

FIG. 22 is a flow diagram illustrating an example process 2200 for deleting a pipeline queue according to some implementations. For example, the process 2200 may correspond, at least in part, to execution of the pipeline queue deletion module 424 by a respective data node 210.

At 2202, the data node receives the pipeline queue delete request from the pipeline manager 208, as discussed above with respect to block 2106 of FIG. 21. For instance, the data node may receive the pipeline queue delete request and an associated job ID.

At 2204, the data node deletes one or more pipeline queues corresponding to the job ID.

At 2206, the data node updates the pipeline queue management table 430 to remove one or more entries corresponding to the received job ID from the pipeline queue management table 430. Similarly, the data node updates the pipeline queue access information table 432, the data produced information table 434, the data consumed information table 436, the data dispatching information table 438, and the data receiving information table 440 to remove any entries corresponding to the received job ID.

At 2208, the data node sends, to the pipeline manager, an indication that the one or more pipeline queues corresponding to the job ID have been deleted successfully. As mentioned above, in response to receiving the indication of successful deletion of the respective pipeline queues from the identified data nodes, the pipeline manager may update the pipeline assignment table 326, by removing one or more entries corresponding to the job ID.

In a map-reduce cluster, such as a HADOOP® cluster or other map-reduce cluster, failures may occur, such as a reduce task failure, a map task failure, or a pipeline queue failure. To avoid re-execution of entire map-reduce jobs, which may be time consuming, implementations herein enable recovery of the pipeline execution from these failures so as to support timely execution results and corresponding decision making.

In some examples of the map-reduce framework herein, when a reduce task or map task fails, the job tracker 214 may reschedule a new reduce task or map task, respectively, to restart the computation that was being performed by the failed reduce task or map task, respectively. For instance, the job tracker 214 may assign the same task ID (with a new attempt number) to the rescheduled task. Accordingly, when a rescheduled reduce task is ready to write data into one or more pipeline queues to which the failed reduce task has already connected (see FIG. 10 discussed above), the rescheduled reduce task data node may send a pipeline assignment request to pipeline manager 208, as discussed above with respect to block 1006. However, the rescheduled reduce task data node may indicate that the request type is “recovery”. Similarly, when a rescheduled map task is ready to read data from one or more of the pipeline queues to which the failed map task has previously connected (see FIG. 18), the rescheduled map task data node may send a pipeline assignment request to the pipeline manager 208, as discussed above with respect to block 1806 of FIG. 18. However, the rescheduled map task data node may indicate that the request type is “recovery”.

As described above with respect to FIG. 12, in response to receiving a recovery type of pipeline assignment request, the pipeline manager 208 may perform operations corresponding to blocks 1218-1230 of FIG. 12 for the recovery of the failed task. For instance, if the failed task is a reduce task, the pipeline manager 208 may determine byte ranges produced by the reduce task from one or more data nodes maintaining pipeline queues that were connected to the failed reduce task to determine one or more byte ranges produced by the failed reduce task. The pipeline manager 208 may send a reply to the data node executing the rescheduled reduce task with information regarding the byte ranges of data that have already been written to one or more pipeline queues so that the rescheduled reduce task will not again write this data to the pipeline queue(s). Thus, the rescheduled reduce task may reconnect to the one or more pipeline queues and may start sending new data that has not already been sent.

If the failed task is a map task, the pipeline manager 208 may determine the byte ranges of data consumed by the map task from the data nodes where the pipeline queues reside. The pipeline manager 208 may inform the corresponding reduce tasks to resend the byte ranges of data to the pipeline queues. For example, a reduce task can retrieve data corresponding to the requested byte ranges from a file in the distributed file system and send this data to the connected pipeline queues. Further, the pipeline manager 208 may send a message to the rescheduled map task to inform the map task node about the identity of one or more pipeline queues previously assigned to the map task.

When a pipeline queue fails, the pipeline manager 208 may send a request for creation of a new pipeline queue. Furthermore, the pipeline manager 208 may use information obtained from one or more connected reduce task nodes and one or more connected map task nodes, that were previously connected to the failed pipeline queue, when performing operations for recovery of the failed pipeline queue.

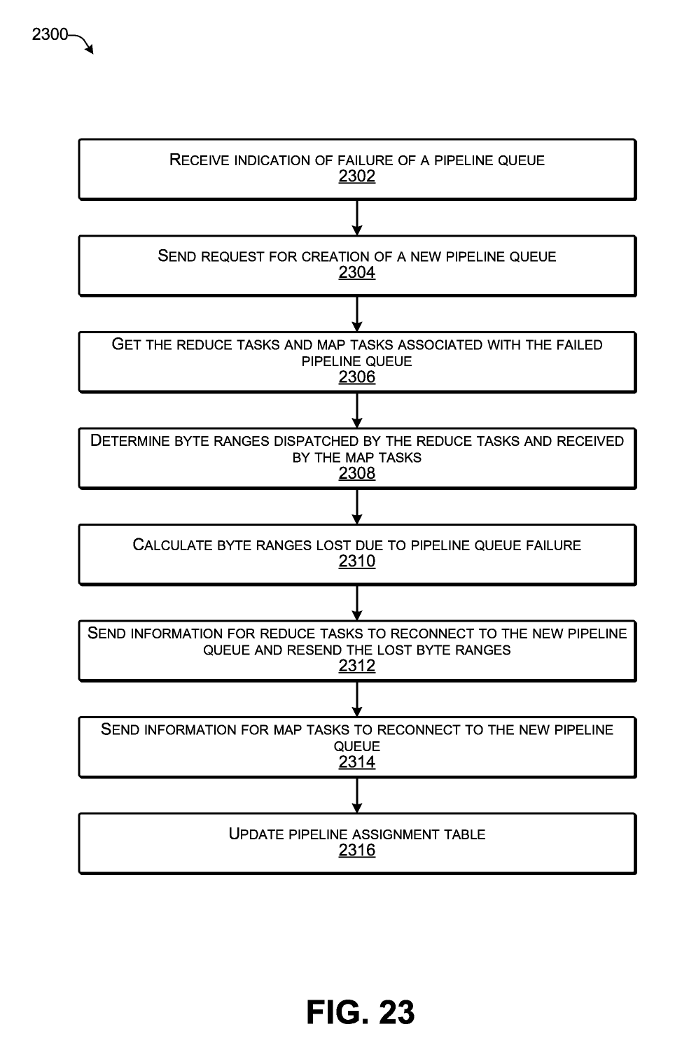

FIG. 23 is a flow diagram illustrating an example process 2300 for pipeline queue failure recovery according to some implementations. In some cases, the process 2300 may correspond, at least in part, to execution of the failure recovery module 320, executed by the pipeline manager 208 to recover a pipeline queue associated with a failure.

At 2302, the pipeline manager receives an indication of a failed pipeline queue, such as based on receipt of a request type “recovery” with a pipeline assignment request.

At 2304, the pipeline manager may create a new pipeline queue (see, e.g., FIG. 6) to replace the failed pipeline queue.

At 2306, the pipeline manager may determine the reduce tasks and map tasks that connected to the failed pipeline queue by checking the pipeline assignment table 326.

At 2308, the pipeline manager may determine, e.g., from the data dispatching information table 438 of the data node where the failure occurred, byte ranges 1108 dispatched by the reduce tasks, and may also determine, from the data receiving table 440 of the data node where the failure occurred, byte ranges 1912 received by the map tasks.

At 2310, the pipeline manager may determine byte ranges lost due to the pipeline queue failure. For example, the pipeline manager may determine the difference between the byte ranges written to the pipeline queue by the reduce tasks, and the byte ranges consumed from the pipeline queue by the map tasks.

At 2312, the pipeline manager may send information to enable one or more data nodes performing the reduce tasks to connect to the new pipeline queue and resend the lost byte ranges.

At 2314, additionally, the pipeline manager may send information to enable one or more data nodes performing the map tasks to connect to the new pipeline queue to begin processing of the lost byte ranges.

At 2316, the pipeline manager may update the pipeline assignment table 326 by replacing the failed pipeline queue ID in column 904 with the new pipeline queue ID in column 904.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

Various instructions, processes and techniques described herein may be considered in the general context of computer-executable instructions, such as program modules stored on computer-readable media, and executed by the processor(s) herein. Generally, program modules include routines, programs, objects, components, data structures, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A system comprising:
one or more processors; and
one or more computer-readable media storing instructions executable by the one or more processors, wherein the instructions program the one or more processors to:
send, to a first data node of a plurality of data nodes, a pipeline queue creation request and a first job identifier (ID) for a first map-reduce job, wherein the first map-reduce job includes a first map task and a first reduce task;
send, to a second data node configured to execute the first reduce task, first queue connection information for enabling the first data node to send data from the first reduce task to the pipeline queue; and
send, to a third data node configured to execute a second map task of a second map-reduce job, second queue connection information for enabling the second map task to receive the data from the pipeline queue.

2. The system as recited in claim 1, wherein the pipeline queue creation request causes, at least in part, creation of the pipeline queue at the data node, wherein the pipeline queue receives data from the first reduce task and provides data to the second map task prior to completion of the first map-reduce job.

3. The system as recited in claim 1, wherein the instructions further program the one or more processors to, prior to sending the first queue connection information:
receive, in response at least in part to sending the pipeline queue creation request, a pipeline queue identifier; and
receive, from the second data node configured to execute the first reduce task, a pipeline queue assignment request, wherein sending the first queue connection information includes sending the pipeline queue identifier in response, at least in part, to the pipeline queue assignment request.

4. The system as recited in claim 1, wherein the instructions further program the one or more processors to, prior to sending the second queue connection information to the second data node:
receive, in response at least in part to sending the pipeline queue creation request, a pipeline queue identifier; and
receive, from the second data node configured to execute the second map task, a pipeline queue assignment request, wherein sending the second queue connection information includes sending the pipeline queue identifier in response, at least in part, to the pipeline queue assignment request.

5. The system as recited in claim 1, wherein, prior to sending the pipeline queue creation request and first job ID to the first data node, the instructions further program the one or more processors to receive, from a client computing device, the first job ID and an indication of a number of pipeline queues associated with the first job ID.

6. The system as recited in claim 1, wherein the instructions further program the one or more processors to:
receive a pipeline assignment request to connect an additional pipeline queue to the second map task;
send an additional pipeline queue creation request to another data node;
receive a pipeline queue ID for an additional pipeline queue; and
send, to the third data node configured to execute the second map task, third queue connection information for enabling the second map task to receive data from the additional pipeline queue.

7. The system as recited in claim 1, wherein the instructions further program the one or more processors to:
receive an indication of a failure of at least one of the first reduce task, the second map task, or the pipeline queue connecting the first reduce task and the second map task;
determine, from at least one of the first data node on which the pipeline queue was created, the second data node on which the first reduce task executed, or the third data node on which the second map task executed, at least one byte range of data that has not been consumed by the second map task; and
send a message based at least in part on the at least one byte range of data.

8. The system as recited in claim 1, wherein the instructions further program the one or more processors to:
receive an indication that the second map task has completed; and
send an instruction to the first data node to delete the pipeline queue.

9. A method comprising:
determining, by a data node in a cluster comprising a plurality of data nodes, that a number of attempts to access a pipeline queue in comparison to a number of successful accesses to the pipeline queue exceeds a threshold; and
sending, by the data node, to a pipeline manager computing device, a request for connecting an additional pipeline queue.

10. The method as recited in claim 9, further comprising:
receiving a pipeline queue identifier (ID) associated with the additional pipeline queue;
determining, by the data node, that a task corresponding to the accesses and the access attempts is a reduce task; and
sending, to a data node corresponding to the reduce task, a pipeline queue connection request including the pipeline queue ID and a reduce task ID to connect the additional pipeline to the data node corresponding to the reduce task.

11. The method as recited in claim 9, further comprising:
receiving a pipeline queue identifier (ID) for the additional pipeline queue;
determining, by the data node, that a task corresponding to the accesses and the access attempts is a map task; and
sending, to a data node corresponding to the map task, a pipeline queue connection request including the received pipeline queue ID and an identifier of the map task ID.

12. The method as recited in claim 11, wherein the map task is connected to a pipeline corresponding to the received pipeline queue ID, such that the map task is connected to two pipeline queues, each receiving data from at least one reduce task.

13. The method as recited in claim 9, wherein the data node is a first data node of a plurality of data nodes in a map-reduce cluster, wherein individual data nodes of the plurality of data nodes include respective monitoring modules executable on the individual data node to monitor accesses and access attempts associated with one or more queues.

14. The method as recited in claim 9, further comprising:
in response to data being written to the pipeline queue by a reduce task, determining a byte range written by the reduce task; and
storing the byte range written into a corresponding byte range array.

15. The method as recited in claim 9, wherein:
the request sent to the pipeline manager computing device comprises a request for connecting the additional pipeline queue to at least one of a reduce task or a map task; and
the request causes, at least in part, the pipeline manager computing device to select the additional pipeline queue based at least in part on pipeline queue usage information with respect to created pipeline queues.

16. One or more non-transitory computer-readable media maintaining instructions that, when executed by one or more processors, program the one or more processors to:
receive an indication of a failure of at least one of a reduce task, a map task, or a pipeline queue connecting the reduce task and the map task;
determine, from at least one of a first data node on which the pipeline queue was created, a second data node on which the reduce task executed, or a third data node on which the map task executed, at least one byte range of data that has not been consumed by the map task; and
send a message based at least in part on the at least one byte range of data.

17. The one or more non-transitory computer-readable media as recited in claim 16, wherein the pipeline queue is indicated to have failed, and the instructions further program the one or more processors to:
send a request to create a new pipeline queue;
receive a pipeline queue identifier for the new pipeline queue;
send the pipeline queue identifier to the second data node to enable reduce task data to be sent to the new pipeline queue; and
send the pipeline queue identifier to the third data node to enable the map task to receive the reduce task data from the new pipeline queue.

18. The one or more non-transitory computer-readable media as recited in claim 17, wherein the instructions further program the one or more processors to:
determine a byte range of data written by the reduce task based on information maintained by the second data node executing the reduce task prior to the failure; and
determine a byte range of data received by the map task based on information maintained by the third data node executing the map task prior to the failure, wherein the message instructs the reduce task to resend data to the new pipeline queue based on a difference between the byte range of data written by the reduce task and the byte range of data received by the map task.

19. The one or more non-transitory computer-readable media as recited in claim 16, wherein the reduce task is indicated to have failed, and the instructions further program the one or more processors to:
determine, from the first node, a byte range of data written to the pipeline queue, wherein the message is sent to a data node executing a rescheduled reduce task to indicate the byte range of data already written to the pipeline queue.

20. The one or more non-transitory computer-readable media as recited in claim 16, wherein the map task is indicated to have failed, and the instructions further program the one or more processors to:
determine, from the first data node, a byte range of data that has already been consumed by the map task, wherein the message is sent to the second data node to indicate data to be rewritten to the pipeline queue to be consumed by the rescheduled map task.
